(19) United States
(12) Patent Application Publication
(10) Pub. No.: US 2022/0260084 A1
(43) Pub. Date: Aug. 18, 2022

(54) Artificial Intelligent Variable Speed Valves with Sensors and a Network controller

(71) Applicant: Michael Antonio Mariano, Rialto, CA (US)

(72) Inventor: Michael Antonio Mariano, Rialto, CA (US)

(21) Appl. No.: 17/178,241

(22) Filed: Feb. 17, 2021

(51) Int. Cl. F04D 27/00; F16K 21/04; F04D 27/02; F16K 17/32

(52) U.S. Cl. CPC F04D 27/001; F04D 27/004; F16K 17/32; F04D 27/0269; F16K 21/04

(57) ABSTRACT

Apparatus is provided to proportionally actuate a valve, furthermore control actuation speed and/or torque. The valve can be actuated manually via an input signal provided by a plurality of controllers. The device has sensory control, wherein sensors is connected in conjunction with the variable speed valve(s) and the electronic output of the sensors is connected to an input upon a microcontroller. The Sensory inputs are utilized to, read/write data, to control the actuation speed and/or position of a variable speed valve autonomously. The UI inputs range from: voice-command, switches, motion sensors, and/or touchscreen. The UI inputs is a means to send signals to the microcontroller, in-which send a signal to a driver, moreover send a signal to control, one or more motors and/or solenoids. Furthermore, will maneuver a plurality of gears and/or driveshafts, at various speeds, to actuate the valve to an accurate and precise position.

### BACKGROUND OF THE INVENTION

The A.I Variable Speed Valve is an electronic operating valve, in-which is constructed with a Stepper Motor, Servo motor, and/or dc motor conjoined to an adjustable gearbox, and moreover, connected to any type of valve. The said motor that actuates the valve is a brush-less and DC operated electromagnetic apparatus, in which a controller converts digital pulses into variable speed mechanical shaft rotation. Stepper motors divide a full rotation into a certain number of steps and can range from micro stepping to full stepping procedures. Stepper motors also allow precise positioning control without the need for a feedback system, as well as being capable of continuous rotation. Dc motor driven device will be accurate because of proper braking techniques, but not as accurate as the stepper motor. The servo motor driven device is the closest to accuracy to the stepper motor driven device, but all are within the 99.4%-99.9% accuracy range.

The A.I Variable Speed Valve has no need for a feed-back system, but in order to operate autonomously, a Sensory feedback system was a necessity. The system monitors, learn, determines, instruct, and/or save a plurality of data, and moreover, the system can teach a user its new data and what it has learned. The system will monitor and learn a plurality of its systems user's and figure out what a user like. For Ex; the apparatus can figure out what temperature and/or pressure a user like to take their shower at during a certain season, or the apparatus can figure out what temperature a woman like to utilize to take their makeup off with. Also, for a user to Operate more effectively, a wired and/or wireless network controller system was implemented to monitor and/or control a plurality of Variable Speed Valve, solenoid valves, and/or sensory inputs from one or more central controller(s) and/or a plurality of local controllers. These missing necessities is where this New apparatus was developed from. Now Introducing, the first Artificial Intelligence Electronic Water Distribution System, the “A.I Variable speed Valves with Sensors and a Network Controller”, and furthermore, will also be titled as the “Variable speed Valves with SCN” or “A I Variable Speed Valve With SCN. The apparatus (Variable speed Valves with SCN) has many functionalities. This Patent will focus mostly on the A I Variable speed Valve and the controller aspect of controlling multiple A I Variable speed Valves and sensors in different locations, from one or more central locations or from a local controller at the Variable Speed Valve. The said apparatus can output water at a local water supply by utilizing the input system via one of the central controllers and/or the said apparatus can output water at a local water supply by utilizing the input system upon one of the local controllers. The said apparatus also can save repetitiously used water depths for anytime access (ex: washing dishes or bathing). The user can auto-fill saved water depths with automatic cut-off. The Variable speed Valves with SCN also has a measurement system to output a plurality of volume sizes by way of motion sensors, auditory signals, and/or the input system upon one of the wired or wireless controller's user interface. The apparatus also has a plurality of sensors and/or automatic timers upon the plurality of microcontrollers and/or Digital signal processors to control and/or monitor sinks, faucets, showers, tubs, sprinklers, swimming pools, toilets, water heaters, water main-lines, swamp coolers, air conditioners, and/or any local water supply. The Variable speed Valves with SCN is the answer for anybody who want to have the faucet of their choice and control their entire home and/or business water supply electronically. The said apparatus is universal, which means, it can control the flow and/or pressure of water in a network buy connecting to any water supply the user has in mind, or the user can use the manual faucet or electronic faucet of their choice. A user can control all their water supply needs from anywhere in the world, while also controlling have fast their Variable speed Valves actuate to their needed position.

### BRIEF SUMMARY OF VARIOUS EMBODIMENTS OF THE INVENTION

The “A.I Variable speed Valves with SCN” now makes it possible to monitor and/or control any pressure, temperature, mixing purpose, mixing colors, and/or turn on/off any Variable Speed Valve type. This system can be utilized within the oil/gas industry, water industry, air regulation systems, and/or can be used to control and/or monitor the flow and/or pressure for any substance and/or air being distributed through a piping system. This will enable the entire facility to be controlled in a network. Various embodiments of the invention include, but not to be limited to, one or more central controllers, a plurality of local controllers, sensors, one or more solenoid valves, and/or one or more Variable speed valves. The central controllers are either a wired or wireless controller with inputs such as physical switches, motion sensors, voice command, touch screen, or any input type. The central controller can also be a mobile device, and/or a computation Device. The central controller is utilized to send control signals to the plurality of local controllers, which a plurality of local controller systems is connected to a plurality of Variable speed valves, and/or water sensors, moreover, the local controllers' control and monitor the flow and/or pressure of a local water supply, but also the local controllers have a user interface to control its devices that are connected to the local water supply. The central controller has hot, cold, and warm water inputs, menu inputs, a microcontroller, electronic water overflow sensor inputs, water monitoring sensor inputs, on-board motion sensors, Bluetooth/WIFI/Lora, and/or any wireless communication transceiver device to send and/or receive control signals to and/or from the local controllers. The central controller functions consist of, depth saving functions to save repetitiously used water depths for any time use, a plurality of water volume size select, automated water-main functions, automated tooth brush timers, and/or water sensors to start and/or stop the flow of water. The central controller is the global controller that can control a plurality of local controllers from anywhere in the world. The apparatus has a plurality of wired/and or wireless Local controller user interfaces which is a microphone, one or more motion sensors, and/or any type of input control signals, microcontroller(s), and a Bluetooth/WIFI/Lora and/or any communication transceiver device to send and/or receive control signals to and/or from a controller. The apparatus has a first Local controller which is constructed with hot, cold, and warm water inputs, menu inputs, electronic water overflow sensor inputs, water monitoring sensor inputs, a microcontroller(s), Bluetooth/WIFI/Lora and/or any wireless transceiver communication device to send and receive control signals to and/or from a second or third local controller. The first local controllers are utilized for easy control of one or more of the apparatus's many functions, moreover, can be set to operate any function the Variable speed Valves with SCN, local device, has to offer. A second local controller is constructed with electronic water overflow sensor inputs, water monitoring sensor inputs, one or more Variable Speed Valve(s), and/or one or more Solenoid Valve inputs. The second local controller is the controllers which is connected to an Electronic drain stopper device, sensors, motorized valves and/or Solenoid Valves. The second local controller is utilized to control and/or monitor the pressure and/or flow at each Variable Speed Valve(s) and/or each Solenoid Valve(s) in a network. The first local controller can also be a third local controller. Some systems have a plurality of local controllers with a plurality of user interfaces to control the local Variable Speed Valve(s) and/or local Solenoid Valve(s). The Variable speed Valves with SCN can be controlled by one or more controllers In Its Network. The electronic mesh network that is created, through all devices being connected on one network, will be called the Mariano Network. The Adjustable gearbox, upon the Variable Speed Valve, is utilized to adjust the speed and/or torque by changing to certain gear patterns embedded into the housing of the gearbox. Changing the adjustable settings of the gearbox will deliver more or less speed and/or more or less torque by changing the gears teeth count for a greater or lower turn ratio. The adjustable gearbox is fully autonomous, in-which it is constructed as electronic and/or manually adjustable. The electronic speed control functionality will allow a user to, for example, speed up valve actuation for a user to not get burned because the valve turns off to slow and/or will allow a user to slow down the speed to gain exact positioning of the valve. The combination of using a certain gearing position and the electronic speed control functionality allow a user to control their valve in a plurality of stages. These stages consist of slow-speed, medium-slow speed, medium speed, medium-high speed, and/or high speed. The Variable Speed Valve can autonomously maneuver to all stages. This Is the “First Full Artificial Intelligence Utility Distribution Machine” for Water, Air, Oil, and/or Gas.

Various embodiments may include variations in the shape, material, construction method, size of various constructed machined parts, gearbox, stepper motor, and/or ball valve used in conjunction with the “Variable speed Valves with SCN”. Various embodiments may also allow for variations in the design of the electronic components used in conjunction with the “A.I Variable speed Valves with SCN”.

### BRIEF DESCRIPTION OF THE DRAWINGS

FIG. 1A-1B—Illustrates two versions of an AI Variable speed Valve with external inline sensors, according to various embodiments of the invention.

FIG. 1C-Illustrates an AI Variable speed Valve's manual and/or autonomous multi speed/multi torque adjustable gearbox and/or adjustable transmission, according to various embodiments of the invention.

FIG. 2A-2B—Illustrates a diagram of an AI Variable speed Valve with internal sensors, designed for indoor/outdoor use, according to various embodiments of the invention.

FIG. 3A-3B—Illustrates a diagram of an AI Variable speed Valve with internal sensors designed for outdoor door use according to various embodiments of the invention.

FIG. 4—Illustrates a schematic of the AI Variable speed Valves with sensors controllers according to various embodiments of the invention.

FIG. 5—Illustrates a diagram of the AI Variable speed Valves with sensors. Furthermore, the Illustration Depicts a first remote control unit and a second main controller unit according to various embodiments of the invention.

FIG. 6—Illustrates the “AI Variable speed Valves with SCN” and its connectivity between a plurality of solar powered and/or turbine powered local controllers. The local controllers connect to one or more sensory inputs and/or Variable speed valve(s) at each water and/or GAS main-line connection of a plurality of homes and/or businesses, furthermore, depicts how the central controller's user interface (or a mobile device) at the water utility company and/or Gas Company can monitor and/or control the pressure and/or flow of water and/or Gas entering each user's home and/or business.

FIG. 7—Illustrates the “AI Variable speed Valves with SCN” and its connectivity between Variable speed Valves, the central controller, and a local controller, furthermore, the local controller and Variable Speed Valves is connected to a Water, Oil, Gas, and/or Air piping system.

FIG. 8—Illustrates the “AI Variable speed Valves with SCN” and its connectivity between the central controller and a plurality of local controllers, furthermore, the plurality of local controllers is connected inside the user's home/business kitchen to motorized valves and/or sensors at each local water supply connection such as faucets, osmosis system and/or osmosis system faucets, and/or pot-fillers.

FIG. 9 Illustrates the “AI Variable speed Valves with SCN” and its connectivity between the central controller and a plurality of local controllers, furthermore, the plurality of local controllers is connected inside a user's home and/or business bathroom to Variable Speed Valves and/or sensors at each local water supply connection such as showers, tubs, sinks, and/or toilets.

FIG. 10A Illustrates the “AI Variable speed Valves with SCN” and its connectivity between the solar powered central controller and a plurality of solar powered local controllers. Furthermore, the plurality of local controllers is connected outside the user's home to a plurality of Variable Speed Valves and sensors at each local water supply connection such as a shower, a tub, spa, and/or a swimming pool.

FIG. 10B Illustrates the “AI Variable speed Valves with SCN” and its connectivity between the central controller, a local controller, Sensors, Variable speed Valves, and/or a water heater.

FIG. 11A—Illustrates a first schematic of the “AI Variable speed Valves with SCN” Network Controllers. This schematic is used to prove the invention. The schematic does not disclose a full version of the capabilities of the system, but it does depict how to control a first version of Variable Speed Valve and sensors in a network.

FIG. 11B—Illustrates a second schematic of the “AI Variable speed Valves with SCN” Network Controllers. This schematic is used to prove the invention. The schematic does not disclose a full version of the capabilities of the system, but it does depict how to control a second version of Variable Speed Valves and sensors in a network.

### DETAILED DESCRIPTION OF VARIOUS EMBODIMENTS

Various embodiments of the invention are described more fully hereinafter with reference to the accompanying drawing, in which some, but not all embodiments of the invention are shown in the figures. Indeed, these inventions may be embodied in many different forms and should not be construed as limited to the embodiments set forth herein; rather, these embodiments are provided so that this disclosure will satisfy applicable legal requirements.

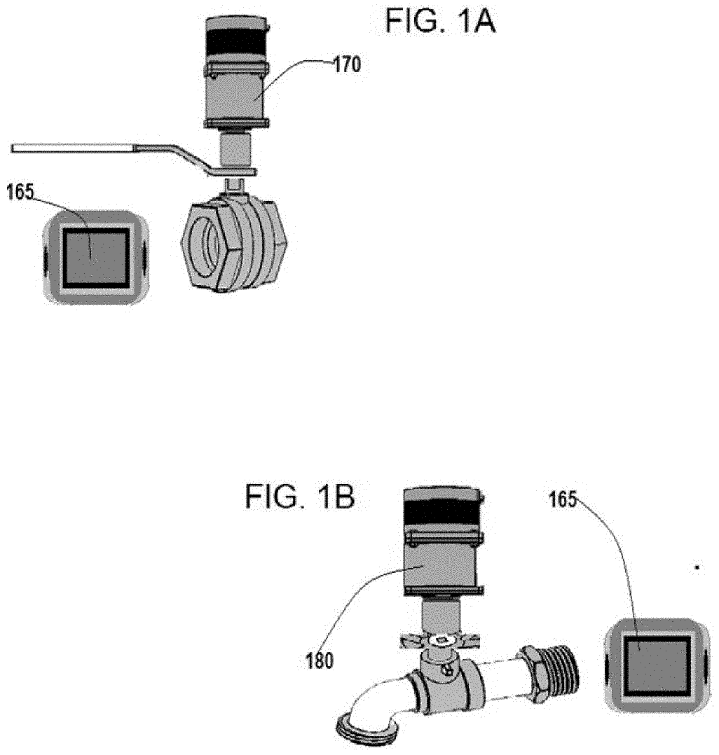

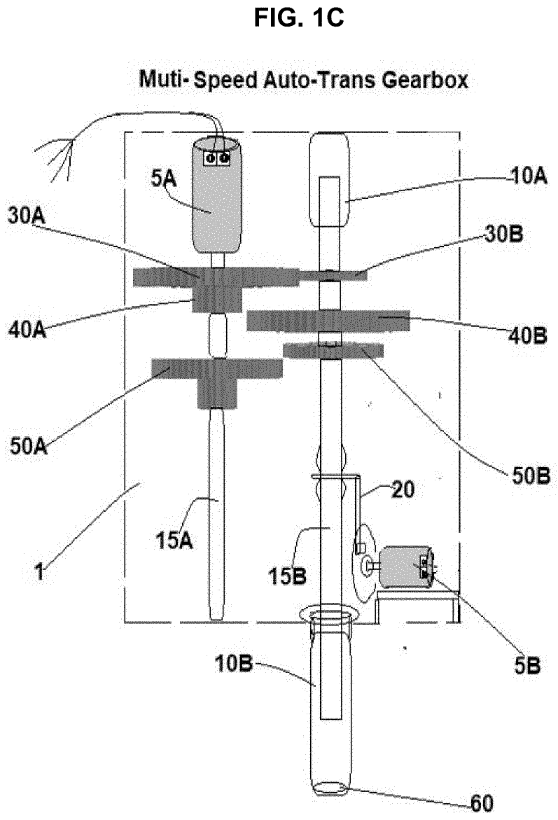

FIG. 1A-1B Illustrates two of the main embodiments of the invention. As shown, a “A I Variable speed Valve” (170) includes a motor (Stepper Motor, DC Motor, AC Motor, and/or Servo Motor), an adjustable gearbox in which can be manually and/or electronically adjusted, a drive shaft, a valve, an external sensory device (165), an all-off switch in which tells the microcontroller the device is completely off, and also is constructed with/without an emergency manual shutoff. These are 7 of the major components that make up the “AI Variable speed Valve”. The “AI Variable speed Valve” constructed with a ball valve, butterfly valves, and/or any valve with no interchangeable parts, are designed to last because it has no interchangeable parts. There are no diaphragms, no washers to ever change, or no needles or wore out springs to change or replace. The “AI Variable speed Valve” constructed with a diaphragm valve and/or any other valves with, diaphragms and/or washers, will have interchangeable parts. You can control either “Variable speed Valve” by means of the Variable speed Valve's specific controller and/or by the means of a plurality of the Electronic water distribution system network controllers. The apparatus can be controlled by any system that can control a motor. FIG. 1-A, furthermore, illustrates the “AI Variable speed Valve” (170) used for indoor/outside use. It can be Used to control all local supply of water in your home/office kitchen or bathroom. The sensory input (165), are utilized for sensing temp, pressure, flow rate, valve position, a substance presence, and/or for automating the valve. The sensory inputs can be embedded with the valve construction and/or the sensors can be external devices. Other specific areas that the “AI Variable speed Valve” and controller (or the “AI Variable speed Valve” alone) can be utilized for range from following: Precisely regulate inside water distribution, Main line automated shut on/off, all water shutoff and regulation solutions, precisely regulate any and all gas measurements (or automatic gas shutoff/turn on), can precisely measure and regulate air pressure, can control the speed of how fast each Variable speed Valve acuate, and multiple other system uses. FIG. 1-B illustrates the “Variable speed Valve” (180) used for outdoor use. The “Variable speed Valve” (180) and controller (or the “Variable speed Valve” alone) can be utilized from a range of the following: Precisely regulate any water and/or gas distribution, water hose (hose bib), washing machines, a gas station pump, Water Mist distribution system (plants), and multiple other system uses. The sensory input (165), are utilized for sensing water temp, water pressure, water flow rate, valve position, and/or for automating the valve.

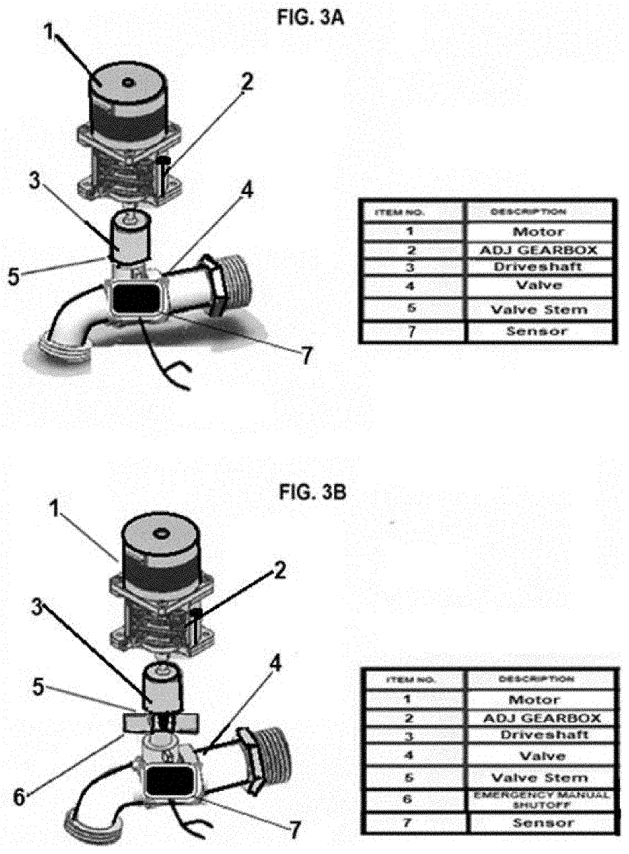

FIG. 1C Illustrates an embodiment of an AI Variable speed Valve's manual and/or autonomous multi speed/multi torque adjustable gearbox (1) and/or adjustable transmission (1). The AI Variable speed Valve with a, manual and/or autonomous, gearbox (1) will be created with, one or more motors (5A) (5B). The first motor (5A) will be the actuating device in-which actuates the valve stem. The second motor (5B) will allow the device to have automatic gear pattern adjustments. This second motor (5B) make it possible wherein a user and/or the AI Controller can make autonomous gear pattern adjustments and/or manual gear pattern adjustments. Moreover, this will allow the Valve to fully automate its speed and/or torque while also adjusting liquid, Air, and/or Gas temperature and/or pressure outputs. The actuating devices ((5A) and/or (5B)) can be any type of motor and/or solenoid, and furthermore, the actuating Device ((5A) and/or (5B)) can also be constructed with one or more motors and/or solenoids. The device will be made with many different speed/torque stages, ranging from, for example: 2-Speed/torque settings—8 Speed/torque settings. In some instances, even more. In this particular embodiment is a 3 speed/torque autonomous gearbox (1) and/or transmission (1). It has 3 separate gearing patterns in which can be adjusted. For Example: Gear Pattern One ((30A and (30B)): is the slowest possible speed settings and the torque range is moderate. Gear Pattern two ((40A and (40B)): has fast possible speed settings and the torque range is very high. Gear Pattern three ((50A and (50B)): has medium speed settings and the torque range is medium. The lever (20) is utilized to manually change the gear pattern settings. In FIG. 3, the Illustration will depict a lever on the outside of the gearbox. The Lever on the outside of the gearbox is connected to the lever (20), in which is connected to the gear select actuating device's (5B) gearing system. The driveshaft (15B) will proportionally move, up and/or down, until it reaches its specific gear pattern to engage upon. Once the gear pattern is engaged, the driveshaft (15B) will lock in place and no longer proportionally move, up and/or down. Now that the gear pattern is locked in place, the actuating device (5a) can now actuate that specific gear pattern arrangement, in-which will actuate the driveshaft (10B). The drive shaft (10B) is connected to the valve assembly at the bottom of the driveshaft (60), and furthermore, can now proportionally Actuate a Valve. The system can be assembled to any valve type. The motor and/or gearbox is a universal and/or a removable device in which can connect to any manual Valve. The motor and/or gearbox system will also be constructed, wherein it cannot be removed from the valve and/or assembled to any valve. This Motorized Valve was constructed with an actuating motor (5A), in which is conjoined to a first plurality of gears upon a first adjustable gearbox drive shaft (15A). A second gearbox drive shaft (15B), with a second plurality of gears, is then connected to, one or more, machined cylinder housing ((10A) and (10B)). The motor will actuate the gears upon the first driveshaft (10A), and moreover, will catch the gears upon the second driveshaft (10b). The second driveshaft (10b) at point (60), will moreover, join the gearbox (1) shaft to any valve. The coupling/drive shaft (10A AND 10B) is lastly, secured to both sides of the gearbox (1) and the valve by machined screws. In conclusion, the Valve is now ready to be Variable Speed Controlled. Please keep in mind that this Valve Assembly will be constructed in many other different ways utilizing similar mechanical parts and/or electrical components. The above is just examples of a functioning variable speed valve, and will be further advanced in the future.

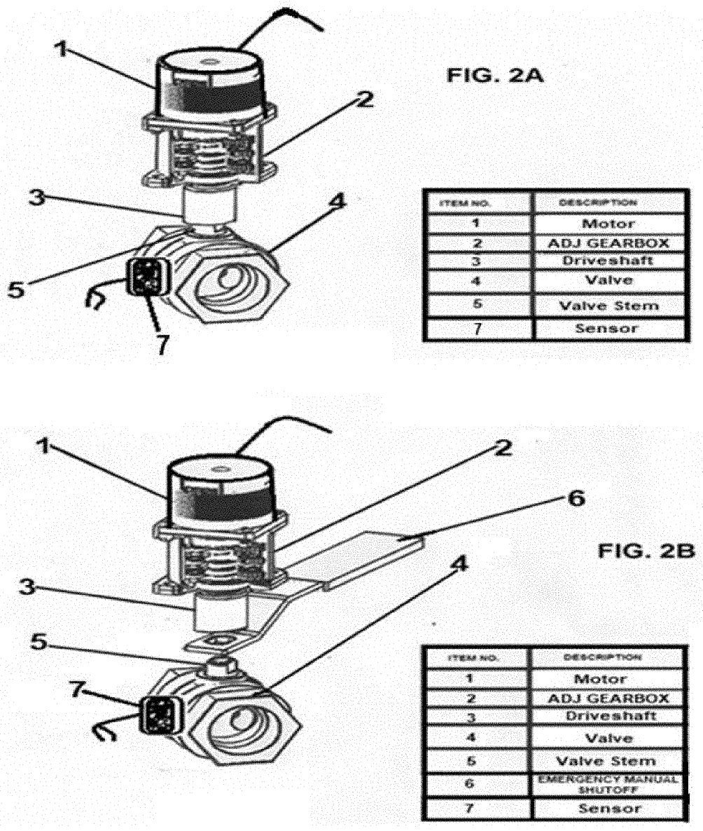

FIG. 2A-2B Illustrates a diagram of the “A I Variable speed Valve” for indoor/outdoor use according to the various embodiments of the invention. FIG. 2-A display the “Variable speed Valve” without emergency shut-off. FIG. 2B display the “Variable speed Valve” assembled with an emergency shut-off (5). This diagram depicts the parts used to make the apparatus functional. The stated “Variable speed Valve was created with one or more motors (1), a precisely ratio gearbox (2), and a valve (4). The device will be made in a plurality of different ways. One alternative way the Variable speed Valve will be created, is by the valve having, one or more motors. This will allow the device to have automatic gear pattern adjustments on one motor and a second motor will be the actuating device in-which actuates the valve stem. Moreover, this will allow the Valve to fully automate its speed and/or torque while adjusting temperature and/or pressure outputs. This second motor make it possible wherein a user can make electronic gear pattern adjustments and/or manual gear pattern adjustments. The gearbox is assembled to the shaft of the motor. The gearbox (2) shaft is then connected to a machined cylinder housing, the coupling/driveshaft (3), to join the gearbox (2) shaft to the valve (4). The coupling/drive shaft (3) which is then secured to both sides (the gearbox and the valve (4)) by machined screws. This was done to create smoother operations and maximum speed and/or torque delivery. The gearbox of the device is adjustable, in which is a means to adjust the gearbox to many different preset gear patterns. For Ex: In order to turn the valve (4) to a precise angle with high torque/slow speed, the motor and gearbox turn ratio had to be changed to a smaller step size. For this to work, a first gearing pattern in the gearbox (2) had to be implemented to decrement the step ratio from 1.8 degrees to 0.008 degrees' step size. This gearing pattern is the normally set gear pattern. This first gear pattern setting is the slowest actuating gear pattern setting, but also the most accurate gear pattern setting. On behalf of the medium torque/medium speed “Variable speed Valve” gearing position, a second gear pattern was implemented in the gearbox. This second gearing pattern was implemented to transform the step size by making the gear box's (2) second gear pattern's gear ratio achieve 100 steps to the said motor (1) original one step 1.8\100=0.018. On behalf of the low torque/fast speed “Variable speed Valve” gearing position, a third gear pattern was implemented in the gearbox. This third gearing pattern was implemented in the gearbox to transform the step size by making the gear box's (2) gear ratio achieve 50 steps to the said motor (1) original one step 1.8\50=0.036. When there was no gearbox (2) present, the step ratio would be too big and turn the “Variable speed Valve” in 2 revolutions, at highest four revolutions. The sensory inputs (7) are utilized for sensing temp, pressure, flow rate, valve position, a substance/substance presence, and/or for automating the valve. The sensory inputs (7) depicted in the illustration are embedded in the valve construction, but the Variable speed Valve sensors (7) can be embedded with the valve construction and/or the sensors (7) can be external devices. It will also have an off switch embedded in the gearbox housing to send a signal to a controller to alert a user that the valve is completely open and/or closed. The “Variable speed Valve” is designed to a user's preference. Each “Variable speed Valve” is designed for any area of distribution that can be controlled by a valve (4). The specific areas that the “Variable speed Valve” and “Variable speed Valve Motor Controller” (or the “Variable speed Valve” alone) can be utilized for range from following: Precisely regulate inside/outside water distribution (sprinkler, swimming pools, spas). It can be Used to control any and all water faucets in your home kitchen or bathroom/office. Other specific areas that the “Variable speed Valve” and “Variable speed Valve Motor Controller” (or the “Variable speed Valve” alone) can be utilized for range from following: Liquid Main line automation, sprinkler pressure automation, all water shutoff/shut-on and regulation solutions, precisely regulate all gas/oil measurements (or automate gas/oil shutoff-turn on), a gas station pump controller, can precisely measure and/or output air (also regulate the air pressure), and multiple other system uses. A Variable speed Valve also come equipped with timers for a user can set timers to automate their valve usage.

FIG. 3A-3B Illustrates a diagram of the “A I Variable speed Valve” for outdoor use according to the various embodiments of the invention. FIG. 3-A display the “Variable speed Valve” without emergency shut-off. FIG. 3B display the “Variable speed Valve” assembled with an emergency shut-off (5). This diagram depicts the parts used to make the apparatus functional. The stated “Variable speed Valve was created with a motor(s) (1), a precisely ratio adjustable gearbox (2), and a valve (4). The device will be made in a plurality of different ways. The gearbox is assembled to the shaft of the motor. The gearbox (2) shaft is then connected to a machined cylinder housing, the coupling/driveshaft (3), to join the gearbox (2) shaft to the valve (4). The coupling/drive shaft (3) which is then secured to both sides (the gearbox and the valve (4)) by machined screws. This was done to create smoother operations and maximum speed and/or torque delivery. The gearbox/gearbox lever (2) of the device is adjustable, in which is a means to adjust the gearbox to many different preset gear patterns. To adjust the gear pattern's in the gearbox of the variable speed valve, a user can twist the gearbox housing and/or a switch/lever (2) will be constructed in-conjunction with the gear box housing. The Gearbox (2) is manually adjustable and/or electronically adjustable. The following will explain why and how the gear patterns where created. For Ex: In order to turn the valve (4) to a precise angle with high torque/slow speed, the motor and gearbox turn ratio had to be changed to a smaller step size. For this to work, a first gearing pattern in the gearbox (2) had to be implemented to decrement the step ratio from 1.8 degrees to 0.008 degrees' step size. This gearing pattern is the normally set gear pattern. This first gear pattern setting is the slowest actuating gear pattern setting, but also the most accurate gear pattern setting. On behalf of the medium torque/medium speed “A I Variable speed Valve” gearing position, a second gear pattern was implemented in the gearbox. This second gearing pattern was implemented to transform the step size by making the gear box's (2) second gear pattern's gear ratio achieve 100 steps to the said motor (1) original one step 1.8\100=0.018. On behalf of the low torque/fast speed “A I Variable speed Valve” gearing position, a third gear pattern was implemented in the gearbox. This third gearing pattern was implemented in the gearbox to transform the step size by making the gear box's (2) gear ratio achieve 50 steps to the said motor (1) original one step 1.8\50=0.036. When there was no gearbox (2) present, the step ratio would be too big and turn the “Variable speed Valve” in 2 revolutions, at highest four revolutions. The sensory inputs (7) are utilized for sensing temp, pressure, flow rate, valve position, a substance/substance presence, and/or for automating the valve. The sensory inputs (7) depicted in the illustration are embedded in the valve construction, but the Variable speed Valve sensors (7) can be embedded with the valve construction and/or the sensors (7) can be external devices. It will also have an off switch embedded in the gearbox housing to send a signal to a controller to alert a user that the valve is completely open and/or closed. The “Variable speed Valve” is designed to a user's preference. Each “Variable speed Valve” is designed for any area of distribution that can be controlled by a hose bib type valve (4). The specific areas that the “Variable speed Valve” and “Variable speed Valve Motor Controller” (or the “Variable speed Valve” alone) can be utilized for range from following: Precisely regulate outside water distribution (sprinkler, swimming pools, spas). It can be Used to control any and all local water supplies outside a user's home/office. Other specific areas that the “Variable speed Valve” and “Variable speed Valve Motor Controller” (or the “Variable speed Valve” alone) can be utilized for range from following: Water Drip Systems, Swamp cooler's, AC's, water hoses, any (hose bib) type valve automation, sprinkler pressure automation, all piping shutoff/shut-on/regulation solutions, precisely regulate all gas/oil measurements (or automate gas/oil shutoff-turn on), can precisely measure and/or output air (also regulate the air pressure), and multiple other system uses. All Variable speed Valve also come equipped with timers for a user can set timers to automate their valve usage. The “Variable Speed Valve will be assembled with an electronic speed controller, a manual speed controller, and/or an electronic and manual speed controller. The “Variable Speed Valve will also be assembled with an electronic gear pattern adjustment system, a manual gear pattern adjustment system, and/or an electronic and manual gear pattern adjustment system.

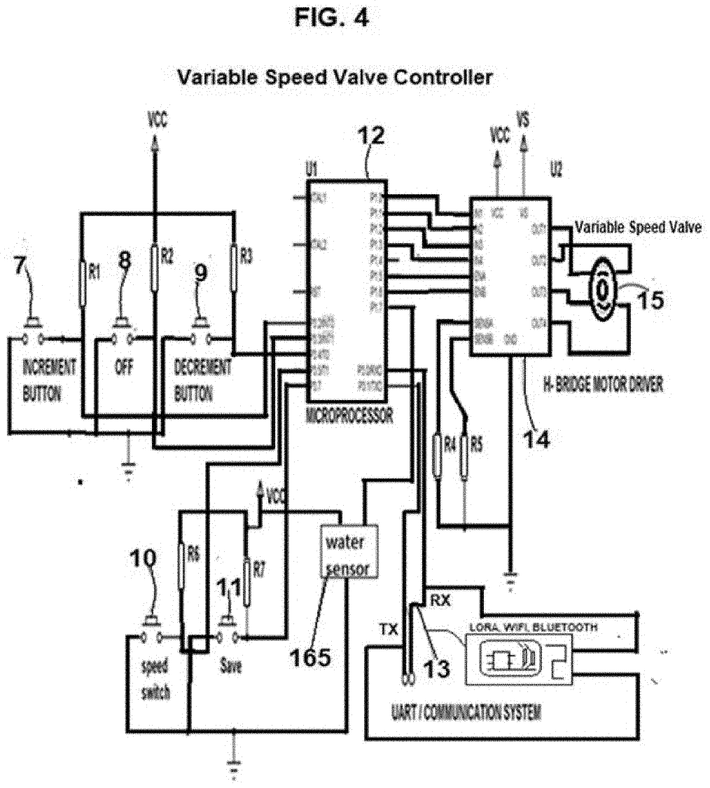

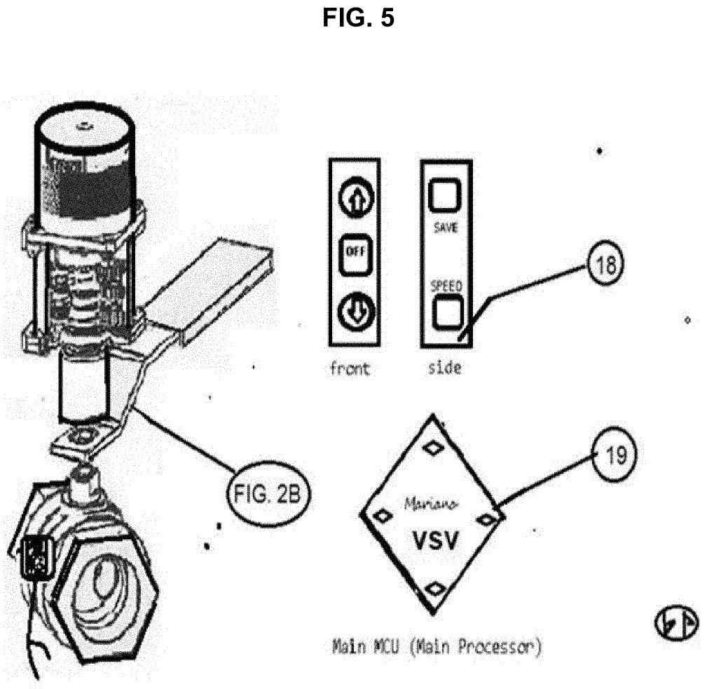

FIG. 4 Illustrates a schematic of a “A I Variable speed Valve Controller”. The “Variable speed Valve Controller” will be embedded in the valve construction and/or will be an external device. As shown, a microcontroller (12), a full h-bridge motor driver (14), some control switches ((7) (8) (9) (10) (11)), a sensory input (165), and a UART system. The UART system (13) is connected to a transceiver (13), to provide wired and/or wireless communication to and/or from the controller and/or the “VARIABLE SPEED VALVE”. Other communication systems that are invented within the time span of this patent will also be utilized with the “A I Variable speed Valve Controller”. Wireless communication ranging from, IR, Bluetooth, LORA-WANN, WI-FI, ZIGBEE, XBEE, and/or any transceiver device (13) will be utilized to transmit and/or receive data from UART. The motor (15) has to use a h-bridge (14) in order to operate correctly. This is because the coils of the motor have to switch polarity to, open and/or close, the Variable Speed Valve. The microcontroller (12) is utilized to control motor speed, motor rotation, to save user and/or sensory data, and/or to allow inputs to control the “Variable speed Valves”. It is also used to output data through speaker(s), LCD screen(s), vibrator motor, Touchscreen(s), and/or a plurality of LED'S, to alert a user that a function is complete. The buttons in the picture are there for the purpose of depicting switches. The Variable speed Valves with SCN User Interface will be operated by voice commands, touch-less sensing, touch screen, and/or push buttons. The Increment switch (7) will allow the user to adjust the “Variable speed Valve” step by step in the open position until the user has reached their preference. The decrement switch (9) will allow the user to adjust the “Variable speed Valve” to increments towards the closed position until the user has reached their preference. By pressing the off switch (8), this will allow the user to fully close the valve despite its position. A second off switch will be embedded in the valve housing of a plurality of different “VARIABLE SPEED VALVE” constructions. The second off switch (8) will be an input to the microcontroller to alert the microcontroller and/or a user that the valve is 100% closed. The speed switch (10) is used to adjust the various different motor speeds programmed to the microcontroller. The speed switch (10) is utilized to control how fast or slow a user want the “Variable speed Valve” to actuate open and/or close. The save switch (11) was added for, if the user has a plurality of valve positions, pressure output settings, and/or sensory data they want to save for future use. This saved data can be used to automate Valve actuation. A user can also set and/or save timer settings, in which can automate the valve actuation. The sensory inputs (165) determine the temperature, flow/pressure rate, substance presence, and/or many more sensor types will be utilized within the apparatus. All of the sensory inputs (165), utilized in conjunction with the apparatus, are commercially sold and communicate with the microcontroller (75) through an input/output pin. The sensory inputs (165), that was stated above will, depending on the end user needs, be utilized in conjunction with one or more Variable speed Valves with SCN devices, furthermore, the sensory inputs (165) send and/or receive data, to and/or from, the microcontroller (75) to monitor, control, determine, and/or to save sensory data that was recorded due to different types of activity at a local Variable Speed Valve. The sensory inputs (165) can also start and/or stop the flow of water. The A I Variable Speed Valve Also Has a Network controller to control one or more Variable Speed Valve's In different locations from one or more central location's and/or from each device local location. This will be further disclosed in FIG. 5-10. This particular “Variable speed Valve Controller” schematic's is present to prove the bare necessities needed to operate a “Variable speed Valve”. This “Variable speed Valve Controller” schematic's is not present to depict the full embodiment of the invention, but only to prove validation.

FIG. 5 Illustrates a “A I Variable speed Valves” With the “Variable speed Valves Motor Controller” according to various embodiments of the invention. The “Variable speed Valves Motor Controller” will be equipped with multiple controller options to choose from. According to various embodiments the “Variable speed Valves with SCN Motor Controller” is assembled with a power supply, a transceiver, a microprocessor, and a motor driver. System can be powered by Solar, Salt water Technology, and/or a water turbine device. Some plurality of systems will come with embedded battery packs and charging systems, while some system will be constructed to power from non-reusable batteries. The controller (18) can be embedded into the valve housing and/or can be an external device. The main unit (19) is a second controller unit, that will be utilized in some wireless controlled Variable speed Valves with SCN devices. Wherein the first controller (18) sends and/or receive wireless data to and/or from the main unit/second controller (19), to control variable speed valves (FIG. 1-FIG. 3) and sensors at the location of the second controller. A mobile device and/or a computation device can also send and/or receive wireless communication signals to and/or from both controllers to control the variable speed valve and/or monitor sensory data at a plurality of different local Variable Speed Valve locations. The mobile device will become a central controller to control Variable speed Valves connected to a plurality of main unit/second controllers (19). From this point, this patent will turn attention from the Variable speed Valve, and turn its attention towards a plurality of Controller and/or User Interfaces. These controllers communicate with all Variable speed Valves in an online network and/or offline network. The following will discuss the Network Controllers different methods of construction and/or different functionalities for different system usages.

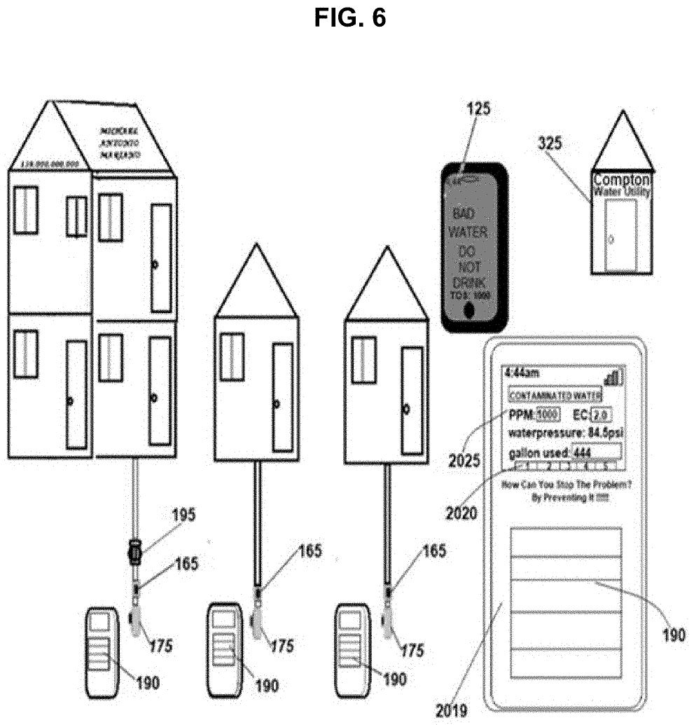

FIG. 6 Illustrates the “A I Variable Speed Valves with SCN” and its connectivity between a plurality of solar powered (190) and/or water turbine powered (195) local controllers (2019) and a plurality of central controllers ((125) and (325)). The illustration further depicts how a A I Variable speed Valve (175) is connected to the local controller (2019) at each water main line connection of each user's home and/or business. Furthermore, depicts how the water company (325), the local controller (2019), and/or a mobile device (125) can control the actuating speed of the Variable speed valve (175), and moreover, control the water pressure and/or flow of the water entering each user's home. Moreover, depicts how the water company (325), the local controller (2019), and/or a mobile device (125) can monitor the actuating speed of the Variable speed valve (175), and moreover, monitor the water pressure, temperature, and/or flow of the water entering each user's home by reading the sensory (165) data. The local controller's (2019) solar panel (190), for example, is first embedded into the top of the water main enclosure. Next, the local controller (2019) and the battery is embedded in the bottom of the water main enclosure. The user interface (2025), for example, is also embedded in the top of the water main enclosure. In a whole, the top of the water main enclosure is the local controller (2019). The local controller (2019) is constructed with a solar panel (190), user interface (2025), microcontroller s, radio controller device, driver, battery, and/or battery charging circuitry. Now, concerning connecting the device for operation. First: connect the Variable speed Valve (175) with sensors (165) to the Water main line input. If the Sensory inputs (165) are external devices, attach the Variable speed Valve (175) to the water main line first and following the Variable Speed Valve (175) connection, connect the external sensory devices (165) to the output of the A I Variable Speed Valve (175). To power-up and/or charge the device, a first charging system method was implemented in-which a user will connect a water turbine generator (195) in-line with the Variable speed valve (175) and/or external sensory (165) valve output. This Water turbine (195) will Charge the device batteries every time water is turned on in the user's home. A second charging system method was implemented in-which a user will connect a Solar Panel (190) to the power input of the local controller (2019) to power up and/or charge the apparatus. These two Power methods were configured wherein a user can power the device without the need to plug the device in. After the A I Variable Speed Valve(s) (175), sensors and/or a user power method is connected, the local controller (2019) is wired and/or send wireless signal to communicate with the sensory inputs (165), the water turbine generators (195), the Solar Panel(s) (190), and/or the Variable Speed Valves (175). Each local “Variable Speed Valve with SCN device, at each home and/or business, can be controlled and/or monitored from its on local user interface (2019) and/or from either central controller's (125) and (325) users' interface. If the water utility company central controller (325) (computation device) turns off a user's home and/or business Water because of unpaid bills and/or servicing purposes, the user cannot use any of their personal controllers (190) or (125) to open and/or close the Variable Speed Valve (175). The user can only regain access to the Variable Speed Valve (175) if a user has paid their water bill and/or servicing is complete, furthermore, the water utility company's central controller (325) must output a communication signal to the individual local controller to unlock the device to allow a user to now use there on personal central controllers (125) and/or local controllers (190) to operate the apparatus. All controllers ((325) (190) (125)) user interfaces is constructed with one or more inputs to proportional actuate one or more Variable Speed Valve's open and/or closed, furthermore, all controllers ((325) (190) (125)) also has visual outputs, auditory outputs, and a microcontroller which contain function's which can monitor and/or control the temperature, pressure, and/or flow of water which is flowing into the user's home and/or business, furthermore, the water main peripheral system has functions and settings to set the water main peripheral to output a predetermined volume of water, to output water on a predetermined time schedule, and/or to output a predetermined pressure of water. The sensory inputs (165) are used to monitor, sense, and/or determine water flow, water pressure, PH level, TDS, EC, contaminants in water, and/or water temperatures which is flowing through the local water supply, moreover, the water sensors (165) send that saved recorded data to the local controllers (190) and/or central controllers ((325) (125)) microcontroller which will send signals to the user interface, to let the user know the Variable Speed Valves (175) position, to monitor sensory (165) inputs, and/or display sensory (165) data and/or valve (175) positioning data. The water turbine generators (195) are an electric generator with its electricity and current generated by how fast the water is flowing through the device via the local water supply. The water turbine generators (195) is connected to the battery charging circuitry upon the local controller (2019) to charge the embedded battery upon the local controller (2019) every time a user runs the water in their home and/or business, while still also receiving a charge from the solar panel (190) upon the local controllers (2019). This charging circuitry allow the local controller's (2019) in the front of each user's home and/or business to self-charge. This specific device will operate in an online and/or offline network. The apparatus can operate on an online network via its Wi-Fi radio controller, but this specific route needs to be connected through a router at each home. The apparatus can operate on an off-line personal network controlled via LoRa-Wan or any type of low power wide area network device. The LoRa-Wan device is very special when it comes to electronic water distribution in an offline network. Bluetooth will be utilized as well, but the communication range is very short. LoRa-Wan is special because it does not need any special towers to communicate in its wide area network. LoRa-Wan will allow each home and/or business to be its on router/tower, which means, the more devices that is connected to local water supplies in front of each user's home and/or business, the better the communication range for the water company to reach a device connected to any home and/or business. The LoRa-Wan device upon each local controller will allow signals to hop off of each local controllers LoRa-Wan device to reach the Variable Speed Valve that it supposes to operate upon. If a personal user wants to operate the LoRa-Wan device, they will need a Variable speed Valve Lora Network Controller. The Variable speed Valve Lora Network Controller directly communicate with the LoRa-Wan device. A user can also utilize a Lora-Wan gateway to hook up to their online network. This will also allow a user to communicate with the LoRa-Wan device at the local controller (2019). If a User has a LoRa gateway, the Variable Speed Valve Mobile APP will communicate with an API, furthermore, the API will transmit data from the world wide web to a user's LoRa-Wan gateway. Once data is reached at the users LoRa gateway, a user can reach any LoRa-Wan device on their private LoRa Wide Area Network from anywhere in the world.

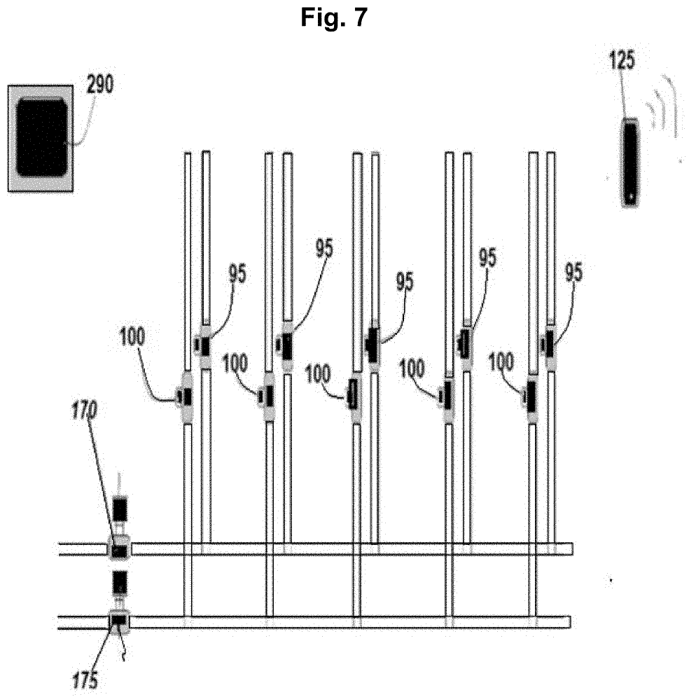

FIG. 7 Illustrates the “A I Variable Speed Valves with SCN” and its connectivity between a central network controller (125), one or more local controllers (290), and a pipeline system. Furthermore, the local controllers (290) are connected to a plurality of Variable Speed Valves upon a water, gas, oil, and/or air piping system. This Illustration depicts how the central network controller (125) and/or local controller (290) can monitor and/or control the flow and/or pressure at each Variable Speed Valve (95) and (100), in-which is connected at each branch of pipelines. This Illustration also depicts how the two main-line AI Variable speed valve's (170) and (175) flow and/or pressure's is controlled via the central network controller (125) and/or local controller (290). All controllers ((290) (125)) user interfaces are constructed with one or more inputs to proportional actuate one or more main line Variable Speed Valves (170) and (175), open and/or closed, to control the overall pressure for all pipeline branches, furthermore, all controllers ((290) (125)) also can proportionally actuate one or more individual branch Variable Speed Valves (95) and (100) to control the flow and/or pressure at each particular pipeline branch. The central network controller (125) and/or local controller (290) can also set, how fast, in-which a user wants each valve to actuate. A user can set one or more Variable Speed Valves to actuate fast and/or they can set a second/third/or fourth plurality of Variable Speed Valves to actuate slowly. A User can set one branch of pipelines to control gas (liquid or vapor) and set the other branch of pipelines to control oil/oil base products. The user can also set one branch of pipelines to control water and set the other branch of pipelines to control Air. The exceptional part of this apparatus is that it can control each individual pipeline from one single controller, and it doesn't matter if a plurality of different substances is flowing through each pipeline. Depending on the controller, each controller will have settings for Water, Gas, Oil, and/or Air. One specific controller (290) or (125) has settings for all the said utilities. This specific set up will be utilized in multi-zone sprinklers systems to electronically adjust the valve actuation speed, water pressure, and/or water flow to keep the sprinklers from wasting water by watering the city streets. This specific set up will be utilized in water distribution environments to electronically distribute water to city streets. This specific set up will be utilized in oil refineries to electronically distribute liquid and/or air to different parts of their specific environment. This specific set up will also be utilized in air pipelines, wherein a user utilizes compressed air in different zones of their work environment, in which the apparatus will control the flow and/or pressure at each valve at each zone and/or at each station. This set up can also be utilized in secure environments to electronically distribute liquid and/or air to different parts of their specific environment. The A I Variable Speed Valve pipeline system can also have sensors attached at each main branch and/or each local pipeline. Each Sensor will be controlled and/or monitored by the Central network controller (125) and/or one or more local controller's (290). This specific electronic water distribution setup, can and will, change in conjunction with this apparatus. What this mean is that this electronic distributed water pipeline setup, can and will be, constructed with any and/or all Variable Speed Valves ((170) (175) (95) (100)), with or without sensors. It will also be constructed with Solenoid Valves and/or Variable Speed Valves to control the actuation speed for each Valve, the pressure at each valve, and/or the flow at each Valve.

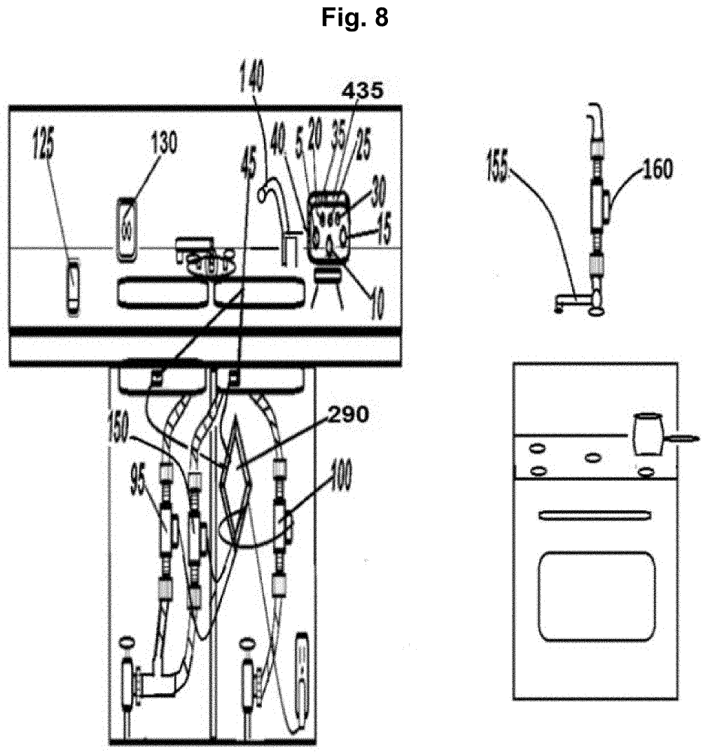

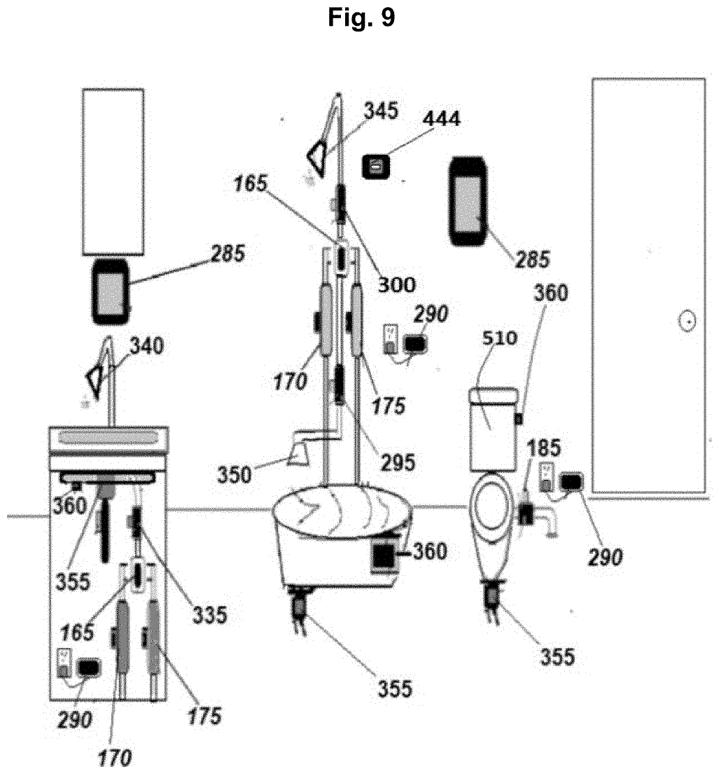

FIG. 8 Illustrates the “A I Variable Speed Valves with SCN” and its connectivity between one or more central controller's (285) and (125), a plurality of local controller's (290) (130) and (435), solenoid Valves, a plurality of Variable Speed Valves( ), and a kitchen's entire piping assembly. A plurality of Variable Speed Vales and sensors is connected to a plurality of local controllers (290), moreover, the local controllers (290) are directly connected to the Variable Speed Valves and Sensors to control and/or monitor a user's home and/or business kitchen local water supply connections such as faucets, osmosis system and/or osmosis system faucets, drain control, and/or pot-fillers. The illustration further depicts a central network controller (435) with internal motion sensors (40), wherein the user interface is constructed with a microphone, switches, touchscreen, motion sensors, Lcd screen, LEDS, and/or audio speaker circuit (35). The mobile device (125) is the second Central network controller. Moreover, the illustration depicts a first local controller (130) with a user interface constructed with a microphone, switches, touchscreen, lcd, led, and/or motion sensors. Next, the Illustration depicts a second local controller (290) with a user interface constructed with a microphone, switches, touchscreen, motion sensors, water level sensory inputs (45), water monitoring sensory inputs, and/or audio speaker circuit (35). The illustration also depicts how, all said controllers (435 and (125) above, connect with one or more wired and/or wireless local controllers (290) to monitor and/or control the water temperature, contaminants in water, flow rate, TDS, EC, PPM, PH, and/or water pressure which is outputting through the Hot water (95), cold water (100), osmosis device (150), and/or pot filler (160) Variable Speed Valves. A solenoid will also be utilized in conjunction with the Variable speed Valve Kitchen Apparatus. The Variable Speed Valve will control how fast each Valve actuate open and/or close and also will control the water pressure coming out of each Individual faucet. The solenoid will control the flow of water coming out of each individual faucet. The solenoid will be connected in-line with the Variable Speed Valves. The said apparatus utilizes four main circuits. The first main circuit that the apparatus utilizes is the wired and/or wireless central controller (435) or mobile device (125); The second main circuit is a first local controller (130); The third main circuit being a second local controller (290); and the fourth main circuit being the water level sensors (45) and/or the water monitoring sensors. These four units, in this particular version, need to be connected in the following order, to have full control of the water supply lines in the user's kitchen. The first connection that need to be made is: Connect the input for the hot water (95), cold water (100), and/or pot-filler (160) Variable Speed Valves to the Water supply line output coming from the kitchens plumbing hot and/or cold water riser lines, moreover, connect a second set of water supply lines to the output of the Variable Speed Valves (95), (100), and/or (160) to the inputs of the user's, faucet or spout, hot and/or cold-water inlet supply lines. Next, connect the input of the osmosis system Variable Speed Valve (150) to the water filtration System Clean water output, moreover, connect the output of the Variable Speed valves (150) to the input of the user's osmosis system faucet's (140) hot and/or cold inlet water supply connection. Next, the central controller (435), once powered on, is connected to the second local controller (290) by automatically sending and/or receiving a wireless Bluetooth, Wi-Fi, Zigbee, Lora-Wan, and/or radio-controlled communication signal, to and/or from, the wired and/or wireless second local controller's (290) Bluetooth, Wi-Fi, Zigbee, Lora-Wan, and/or radio controller device. Once the devices shake hands, the Apparatus is ready for full operation. The said Bluetooth, Wi-Fi, Zigbee, and/or Lora-Wan Radio Controlled (85) communication system is utilized with this apparatus in order to communicate with the apparatus without having to use an infrared remote, which an infrared remote can be used, but an infrared remote can only operate if you are pointing the infrared remote directly at the sensor. The Bluetooth, Wi-Fi, Zigbee, and/or Lora-Wan, Radio Controller (85) utilized in conjunction with the apparatus are commercially sold modules that contains an on-board antenna, an on-board radio signal controller, and a on-board microcontroller. Using a radio-controlled type of communication signal allows operation of the apparatus from anywhere around the user's home and/or business, hence the said radio controller devices also allow an internet connection to operate the apparatus from anywhere in the world. All systems controllers (435), (290), (130), and (125)) will work online while maintaining an internet connection and/or also all systems controllers (435), (290), (130), and (125)) will fully work offline via its on private network. The second connection that need to be made is: The user need to connects the wired and/or wireless communication output signal from the first local controller (130), to input a wired and/or wireless connection to the wired and/or wireless second local controller (290). If the user has the first local controller (130), once powered on, the wired and/or wireless first local controller's (130) transceiver device will automatically broadcast a signal to connect to the wired and/or wireless second local controller's (290) Bluetooth, Wi-Fi, Zigbee, and/or Lora-Wan transceiver/radio controller device. The first local controller's (130) microphone, switches, touch screen, and/or motion sensor (40) type user interface send input signals to a microcontroller, in-which, send a further signal to its transceiver device. Furthermore, the first local controller (130) transceiver sends a wired, wireless, and/or touch-less signal to the second local controller's (290) transceiver/radio controller. Moreover, the radio controller then sends a wired and/or wireless signal to the microcontroller to send a signal to operate the Hot (95), cold (100), osmosis (150), and/or pot filler's (160) Variable Speed Valves. The first local controller (130) can also be set, in-which it can control the actuation speed of a particular valve and/or turn on and/or off a specific Valve. The central controller (435) also has microphones, touchscreens, LCD screens, embedded motion sensors (40), and/or any type of switches as its user interfaces inputs. The microphones, switches, touchscreen, and/or embedded motion sensors (40) upon the central controller, are utilized to send input signals to a microcontroller, in-which, send a further signal to its transceiver device. Furthermore, the central network controller (435) transceiver sends a wired, wireless, and/or touch-less signal to the second local controller's (290) transceiver/radio controller. Moreover, the radio controller then sends a wired and/or wireless signal to the microcontroller to send a signal to operate the Hot (95), cold (100), osmosis (150), and/or pot filler's (160) Variable Speed Valves. The device can have a plurality of central Network controllers (435) controlling one or more Variable speed Valves and/or the device can have a plurality of local controllers (130 and/or (290) controlling one or more Variable Speed Valves. All central controllers (435) and/or local controllers ((130) and (290)) microphone, touch screen, switches, and/or motion sensors type user interface can each be individually set to operate a different task or functions of the “Variable speed valves with SCN”. The Third connection that need to be made is the water sensors: The water sensors (45) have a wired and/or wireless output connection signal, which connects by sending and/or receiving a wired and/or wireless signal to and/or from the inputs of the second local controller (290). The Water Sensors that will be utilized is level sensors, contamination sensing sensors, Temperature sensors, pressure sensors, and/or flow sensors. Once the central controllers (435) (125), the first local controllers (130), and/or as depicted, the water level detect sensors (45) is connected to the second local controller (290), all said controllers can send and/or receive control signals to and or from the second local controller (290) transceiver and/or microcontroller. The second local controller (290) microcontroller then will send a output control signal to the driver circuit, which in turn, output a signal to control the Hot water (95), cold water (100), osmosis (150), and/or pot filler (160) Variable Speed Valves, in-which is connected to the users hot and/or cold water kitchen supply lines. Once, the second local controller (290) send the control signal to the driver, the driver will then output a signal to actuate the Variable Speed Valves selected by the user. The second local controller (290) then send a feedback signal to the wired and/or wireless central controller (435) (125) and/or local controllers (130) to output signals to the user interface to a plurality of Leds, touch screens, LCD, vibrator motors, and/or speakers to let the user know that a specific task is starting and/or complete. A specific task meaning, if the user presses the hot water button (5) up or down, the apparatus will actuate the hot (95) Variable Speed valve, hence the device will then send a visual, auditory, and/or tactile feed-back signal to the user. If the user presses the warm water button (10) up or down, the apparatus will actuate the hot water (95) and cold water (100) Variable Speed valve together, hence the device will then send a visual, auditory, and/or tactile feed-back signal to the user. If the user presses the cold-water button (15) up or down, the apparatus will actuate the cold water (100) Variable Speed valve, hence the device will then send a visual, auditory, and/or tactile feed-back signal to the user. The Local controllers ((130 and (290)) can also be fully controlled by the central network controller (435), a computation device, and/or the mobile device (125) and (FIG. 6-FIG. 12) said Bluetooth, Lora-wan, Wi-Fi, and/or Zigbee transceiver/radio controller device. The mobile device (125) and computation device applications will consist of the exact functionalities as the central controller (435). The central controller (435), the computation device, and/or the mobile cellular device (125) All said central network controllers have full control of the “Variable Speed valve with SCN” system, moreover, the central controller (435), the computation device, and/or the mobile cellular device (125) also have full control of a plurality of “Variable Speed valve with SCN”, systems. This mesh network system is utilized to control entire business's and/or home's water supply systems. Moreover, the Mesh Network system (Mariano Network) goes for all versions and all figures within this Patent. The “Variable Speed valve with SCN” has a plurality of other functions which a user can use for their convenience. The cup size function operates without any sensors or hardware needed to measure the range of water outputted from the spout. The cup size function was configured by knowing that all homes water pressure ranges from 80-85 psi. If the home and/or business pressure is above or below the standard pressure, the user will have to configure the pressure settings mode upon one of their controllers. This will allow a user to set their standard pressure, and furthermore, allow the user to cycle through a plurality of delay time cycles, in-which is utilized to always allow a user to always get dispensed the correct volume amount of water that is selected. Moreover, a user can select automatic calibration as well, to enable the Variable Speed Valves to actuate the valve at a certain speed and/or allow the valve to find its on pressure/speed settings to dispense the correct volume size. Once a user configures their manual and/or automatic pressure calibration setting, all that had to be done now, was to measure the time and the space of half cup or one cup of water coming out of a faucet. The microcontroller is utilized to: For example, if half cup of water took 1.5 seconds to be dispensed from the spout, we then multiply that 1.5 seconds×2, which equal one cup of water taking 3 seconds to be dispensed from the water spout. If one quart equals four cups of water, we then multiply 3 seconds (time one cup take to dispense)×4 to achieve a precise quart (etc.). The system can output any specific volume or quantity of water from any measurement system. The Hot water (95), cold water (100), osmosis (150), and/or pot filler (160) Variable Speed valves used, in conjunction with the “Variable Speed valve with SCN”, will first actuate the valve open to a user set pressure settings. Once the Hot water (95), cold water (100), osmosis (150), and/or pot filler (160) Variable Speed Valve actuate on to the user's pressure settings, this now allows the configured Pressure settings to calculate the time, and space, in direct connection to the pressure that was set, in-which now will allow the “Variable Speed valve with SCN” to time a precise water measurement for all homes and businesses. Now concerning the central controller (435) (125) and/or local controllers (130) and (290)) user interface controls. First, the said apparatus hot (5), cold (15), and/or warm (10) inputs is utilized upon the system for the user to output selected water temperatures and/or water pressure from the local water supply for a prolonged period of time. Second, the central controller controls (435) (125) and/or local controllers (290) can all select and/or control what temperature and/or pressure of water is outputted from the users sinks and/or faucets. The user can set they're on individual motion sensor(s) circuit (40) on the central controller (435) and/or can set there on inputs and/or motion sensors upon one or more first local controller (130). This functionality of the Motion Sensors (40) and/or (130) allows each sensor to be individually set, in which is utilized to activate a temperature and/or pressure for a specific valve, hence that said function will be started anytime the user activate that individually set input and/or motion sensor circuit(s). The Motion Sensor circuit(s) (40) and/or (130) can also, if the water is running, turn the water off. The menu button (20) is there to select and/or change the temperature and/or counter settings in save water depth modes or to fill sink/fill tub settings, to set electronic drain options, to set power saving modes, to set pressure setting mode, to manage mesh network, to manage time settings on the LCD/touchscreen, voice command setup, manage valve actuation speed, and/or to turn the system vibrator and/or audio speaker system on and/or off. A second feature of the apparatus is Water depth mode. Once water depth modes are set, it enables the user to utilize the fill sink/tub mode button (25). Water depth modes allow the user to save a plurality of preferred depths of water that is used normally (to wash dishes and/or to get in the tub). Sink/tub fill up button (25) is to activate the saved water depths timer, temperature, and/or pressure that was selected during the saving procedure by way of the press of that particular button. A Motion Sensor Circuit ((40) and/or (130)) and/or a input signal upon a plurality of central and or local controllers ((435) (125) (130)) can also be set to start, pause, and/or stop fill sink/fill tub mode. The water depth saving function for sink/tub fill up was configured by utilizing a counter/timer program within the microcontroller of all the controllers. Once the user selects to change a specific water depth mode in the menu, the user should select the temperature and/or pressure from an input upon the controller. After the user has selected there preferred water temperature and/or pressure, the Central and/or local controller's ((435) (125) (130)) will then send a control signal to the second local controller (290) to send a control signal to the driver circuit to actuate an electronic stopper device (355) closed, furthermore, the controller will then, receive a signal from the second controller (290), and moreover, send a second control signal to the local controller (290) which outputs a signal to actuate the hot (95) and/or cold (100) Variable Speed Valves to turn the local water supply on. Next, the central controller's ((435) (125)) microcontroller, the first local controller's (130) microcontroller, and/or second local controller's (290) microcontroller (75) will then start a timer/counter program to count the time it takes for the user to finish filling there sink and/or tub. Once the user has reached their preferred depth, the user should press the menu button to save the time from the timer/counter program. Once setting is saved, the hot water (95) and/or cold water (100) Variable Speed Valves will automatically actuate off. The electronic drain stopper (355), mentioned above, are commercially sold products and communicate with the microcontroller (75) through an input/output pin. The electronic drain stopper (355) can be set to actuate back open by a timer and/or the user can speak a word, use an input, or select a motion sensor circuit upon one of the controllers ((435) and (130)) to control the actuation of an electronic drain stopper device (355). If the user wants to start that saved water depth. The user should activate one of their sinks fill up/tub fill up modes by utilizing the sink fill up/tub fill up input (25) upon the central controller (435), local controller (130), and/or the mobile device (125). Once pressed or signaled, the central controller (435), local controller (130), or the mobile device (125) will then send a control signal to the second local controller (290) to send a control signal to the driver circuit to actuate the electronic stopper device (355) closed, furthermore, the controller will then send a second control signal to the local controller (290). In which the second local controller will now output a signal to the driver circuit to actuate the hot water (95) and/or cold water (100) Variable Speed Valves to turn on the local water supply. The local water supply is actuated on for the same water temperature and/or water pressure that was, selected and saved, during the water depth fill up mode, hence the microcontroller will start the timer/counter program to start counting down from the saved time until it reaches zero. Once the counter reaches zero, the second local controller (290) then will send a second output control signal to the driver circuit, in which will output a signal to actuates the Hot water (95) and/or cold water (100) Variable Speed Valves off. Once the water is actuated off, the central controller (435) (125) and/or local controllers ((130) (290) will alert the user by a touch screen, Leds, a vibrator starting to vibrate, and/or auditory speaker output. For example, a user will be alerted by the controller: making a tone and/or saying “water turning off”, to let the user know that the sink and/or tub fill up mode is complete. This will allow the user to not have to watch their water while waiting to wash their dishes and/or fill there tub up. The water over-flow sensors (45) are connected to the side of the user sink(s), as shown in both ((FIG. 8) (FIG. 9)) by way of (for example a magnetic enclosure or an enclosure with a sticky double sided adhesive tape). This particular illustration depicts a plurality of water overflow sensors (45), which is also depicted in ((FIG. 8) (FIG. 9)). If a body of water reach the height and/or position of where the user placed any of the said water over-flow sensor (45), the water over-flow sensor (45) will then output a signal to the input of the microcontroller upon the second local controller (290), hence the second local controller (290) will then output a signal to the driver circuit, which automatically turn both hot water (95) and/or cold water (100) A I Variable Speed Valves off until the water is positioned under the inputs to the water over-flow sensors (45). Once the body of water is under the water over-flow sensors (45), the apparatus can then be operated again. As shown in all figures, different types of Water sensors (45) will be utilized within this specific device as well, in which will monitor, water temperature, contaminants in water, PH level, TDS, PPM, EC, Water pressure, and/or water flow rate. The vibrator and/or audio sound system circuit (35) is utilized upon the system as an audio output signal and/or tactile indicator to the user. The vibrator and/or audio circuit (35) is connected directly to the outputs of the microcontroller or digital signal processor upon the central controller (435) and/or the microcontroller or digital signal processor upon the local controller's ((290) and (130)). The vibrator is a very small dc vibrator motor, which is utilized in the circuit as a physical indicator to the user. The vibrator (35) vibrates the wired and/or wireless central controller (435) and/or local controllers (130) (290) if a button is pressed, if one or more motion sensor(s) are activated, if starting water depth fill-up mode, if starting or stopping sink/tub fill up mode, if the water level sensors is activated, if the electronic stopper is activated, and/or if a temperature is reached. The controllers can also vibrate to let the user know how many cups, quarts, liters, milliliters, gallons, and/or pints of water a user's selected inputs and/or motion sensors are operating upon. The speaker sound system (35) is utilized in the circuit to play audio and/or music files or as an audio indicator to the user. The speaker sound system (35), upon the central controller's (435) (125) and/or local controllers (130) (290) is also utilized to sound out a song, tone, and/or speech if a button is pressed, if one or more motion sensors (40) upon the local controllers (130) (290) and/or the central controllers (435) are activated, if starting water depth fill-up mode, if stopping water depth fill-up mode, if the water level sensor (45) is activated, and/or if a certain temperature is reached. The speaker sound system (35) can furthermore, be utilized to let the user know what volume size of water the apparatus is selected to output through their water distribution device. The voice command input microphones and/or the audio system speakers is commercially sold products that contains an analog to digital converters, digital to analog converters, Codec(s), an on-board microcontroller, and/or speakers and/or microphones connections for audio input and/or output functions (EX: Audio Bluetooth, kleernet, jukeblox, si3000, EPSON TEXT TO SPEECH IC, and/or etc.). The central and/or local controllers can control any motorized valve, but to further limit the claims in this patent, The central and/or local controllers can also control any type of motorized valve that can be controlled, wherein the valve speed and/or torque can be manually and/or electronically adjusted. These controllers are exclusively built for any motor type system. It can control a servo motor, dc/ac motor, and/or a stepper motor type motorized valve.

FIG. 9 Illustrates the “A I Variable Speed Valves with SCN” and its connectivity between one or more central controller's (285), a plurality of local controller's (290) (444), Solenoid Valves and/or Variable Speed Valves, and a bathroom's entire plumbing assembly. A plurality of Variable Speed Valves and sensors is connected to a plurality of local controllers (290), moreover, the local controllers (290) are directly connected to the Variable Speed Valves and Sensors to, control and/or monitor, a user's home and/or business's bathroom local water supply connections such as, a shower (345), tub (350), combination ((345) (350)), sinks (340), and/or toilets (510). This particular setup depicts dual central controllers (285), but moreover, a single central controller can control a plurality of bathroom's in a user's home and/or business. The central controllers (285) are either self-contained wired and/or wireless controllers with user interface inputs such as physical switches, motion sensors, voice command, touch screen, and/or any input type. The central controllers (285) can also be a mobile device (125) and/or a computation Device. The central controllers (285) are utilized to send and/or receive control signals to and/or from the plurality of local controllers (290), in which are directly connected to the local water supplies in conjunction with the shower (345) and tub (350) combination, sinks/faucet s (340), and/or toilets (510). The local controllers (444) are a first local controller, in which have their own user interface to control its on individual peripheral devices. This first local controller's (444) user interface is constructed with a microphone, switches, touchscreen, motion sensors, LCD screen, LEDS, and/or audio speaker circuit. This first controller has the same construction and/or functionalities as the first local controller in ((FIG. 8 (130). Moreover, this first local controller's (444) is utilized to start and/or stop the flow of water in which is flowing out of the tub and/or shower. Furthermore, for example, if a user is in the shower and they want to quickly turn the water off to wash up, the user can make a quick wave at the wired and/or wireless first local controller (444), and it will start and/or stop the flow of water in milli-seconds. The second local controller's (290) also have their own user interfaces to control its individual peripheral devices. The plurality of local controller (290) systems all have inputs and/or outputs to connect a plurality of Electronic Drain stopper (355) devices, moreover, the Electronic Drain stopper (355) devices are connected to the shower (345) and tub (350) combination, sinks (340), and/or toilets (510). The Electronic drain stopper (355) is an electronic actuating drain stopper that actuates open and/or close by a user activating an input upon the user interface upon the central controllers (285) and/or the local controllers (444) (290). The Electronic drain stoppers (355) can also be actuated to a predetermined position and/or can be activated to actuate by a predetermined time schedule. This particular local controller (290) that's connected to shower (345) and the tub (350) combination local water supply is constructed with Hot water (170) and/or cold water (175) Variable Speed Valves, water monitoring sensors (165), water overflow sensors (360), and solenoid valves (shower (300) and/or tub (295) selection valves, but can also utilize one multi-port Variable Speed Valve to select the shower (300) and/or tub (295). The central controllers (285) and/or the local controllers (290) can monitor the temperature and/or water purity by its user interface's Leds, touchscreen, and/or speaker system, but also the central controllers (285) and/or the local controllers (290) can control the temperature, pressure, and/or flow of water which is outputting from the shower (345) by the user activating the menu, hot, cold, and/or warm water inputs upon the central (285) and/or local controllers (290). The user can select one or more shower (345) spout outputs by utilizing an input on one of the controllers ((285), (444), and (290)) to select the specific shower solenoid valve (300). The shower (345) system have settings which a user can set and/or save a plurality of settings to operate the peripheral on a predetermined temperature, predetermined time schedule, and/or the user can play a predetermined song utilizing the apparatus's wired/and or wireless audio system (505). The user can select one or more tub spouts (350) outputs by utilizing an input on one of the controllers ((285), (444), and (290)) to select the specific tub solenoid valve ((295). The Tub (350) settings can control and/or monitor the temperature, flow, pressure, and/or water purity by its user interface's LED s, touchscreen, and/or speaker system. The central controllers (285) and/or the local controllers (444) (290) can control the temperature, pressure, and/or flow of water which is flowing into the tub (350) by the user activating the menu, hot, cold, and/or warm water inputs upon the central (285) and/or local controllers (290). The tub (350) system has water overflow protection sensors (360) and/or timers that will never let a user's tub (350) over flow. Also, the system consists of functions in which a user can set and/or save a plurality of settings to operate the peripheral on a predetermined temperature, a predetermined volume of water, predetermined time schedule, and/or the user can play a predetermined song utilizing the apparatus's wired/and or wireless audio system (505). The particular local controller (290) system that's connected to the sink and/or sink's faucet's (340) local water supply is constructed with Hot water (170) and/or cold water (175) Variable Speed Valves, water monitoring sensors (165), water overflow sensors (360), electronic stopper device (355), and flow control solenoid valves (335). The central controllers (285) and/or the local controllers (444) (290) can monitor the temperature, water pressure, flow-rate, and/or water purity by its user interface's LED s, touchscreen, and/or speaker system, but also the central controllers (285) and/or the local controllers (444) (290) can proportionally control the temperature, pressure, and/or flow of water which is outputting from the sink (345) by the user activating the menu, hot, cold, and/or warm water inputs upon the central (285) and/or local controllers (290). The User can, manually, electronically, and/or proportionally change have fast their Variable Speed Valves actuate open and/or close. This will be greatly used wherein a home has an electronic proportionally controlled faucet system, and the user don't want to get burned do to slow actuation of a valve system The AI Variable speed valve controllers can, automatically speed itself up to, shut off do to hot water temperatures. The flow control solenoid Valve (335) is also utilized within the apparatus to stop the flow of water immediately. The sink (345) system has water overflow protection sensors (360) that will never let a user's sink (345) over flow. Also, a user can set and/or save a plurality of settings to operate the peripheral on a predetermined temperature, a predetermined volume of water, a predetermined pressure, predetermined time schedule, and/or the user can play a predetermined song utilizing the apparatus's wired/and or wireless audio system (505). The particular local controller (290) system that's connected to the toilet's (340) local water supply is constructed with water overflow sensor (360), electronic drain stopper device (355) inputs, solenoid Valve (185), and/or Variable Speed Valves (185) to control the water inputting into the toilet. The central controllers (285) and/or the local controllers (444) (290) can monitor the water level and/or water refill level by its user interface's Leds, touchscreen, and/or speaker system. Also, the central controllers (285) and/or the local controllers (290) can control the flow and/or pressure of water which is flowing into the toilet, at the local water supply, by the user activating the menu and/or the toilet on/off inputs upon the central (285) and/or local controllers (444) (290). The central (285) and/or local controllers (444) (290) can also be utilized to connect to an electronic toilet/electronic flushing device's wireless transceiver, and moreover, is utilized to send a wired and/or wireless signal to flush the toilet. The toilet flushing device can also send a signal back to a user interface to alert a user that flushing is complete or to activate a certain function upon the controller like hand wash mode. The toilet (340) system has water overflow protection sensors and/or water flow/pressure sensors (360) that will send a signal to the solenoid/Variable Speed valves (185) to start and/or stop all flow of water at the toilet if water over/under flow is detected or if the flow/pressure sensor readings is accurate to a user's settings. A User can also set a timer to refill the toilet after a flush. The toilet (340) system consist of functions which a user can set and/or save a plurality of settings to set the toilet (340) system peripheral, in which these settings are utilized to output a predetermined volume of water, to operate on a predetermined time schedule, and/or if a plurality of toilets is present, the user can select which toilets they want active and which toilets they want inactive. An electronic drain stopper (355) device, if utilized, will cease all flow of drain water by completely closing the drain and also will cease all flow of clean water which is flowing into the toilet at the local water supply. This particular function will allow a user to shut-off their toilet(s) water supply and/or close there drain pipe immediately in case a user drop something inside the toilet accidentally. As stated above, the controller (285) (444) (290) can connect to a plurality of toilets (340), moreover each controller can be individually set to send and/or receive data to and/or from the local controller at a specific sink (345) to auto detect a flush, moreover, once a flush is detected the local water supply at the sink (345) will automatically turn on the water to a predetermined water temperature, to a predetermined water pressure, a predetermined quantity of water, and/or for a predetermined time period, furthermore, automatically turn the sinks (345) water off after the predetermined time limit has expired. The Local controllers (290) can auto-detect toilet flushes by receiving data from the Toilet device's transceiver, by reading data from the water sensors connected to a toilet, and/or by a user activating a switch at the toilet. If a user has multiple toilets on the Mariano Mesh network, they can all be set to auto-detect a flush. The flush auto-detect function is utilized to operate a plurality of devices and/or output water at a specific local supply of water autonomously.

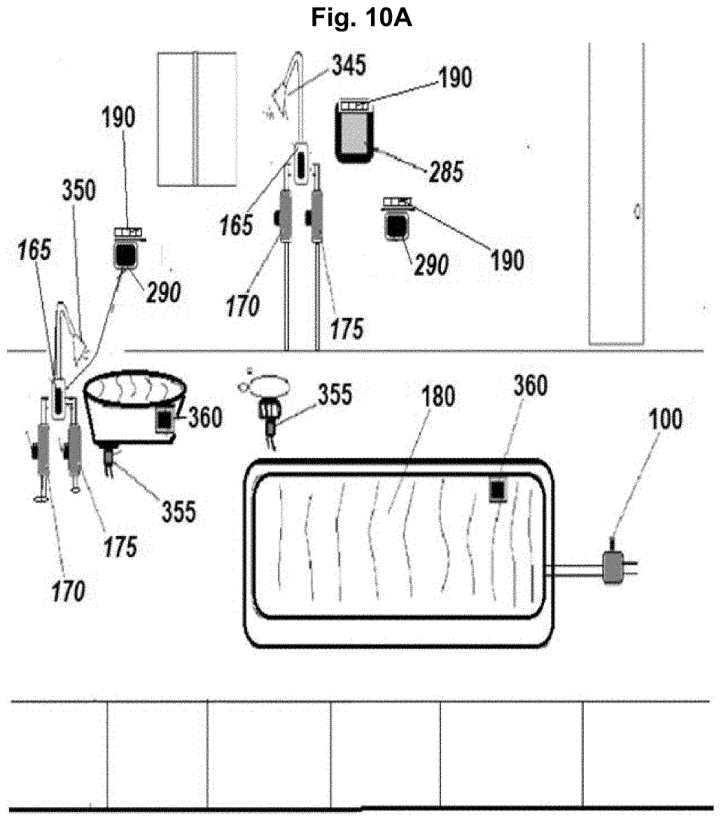

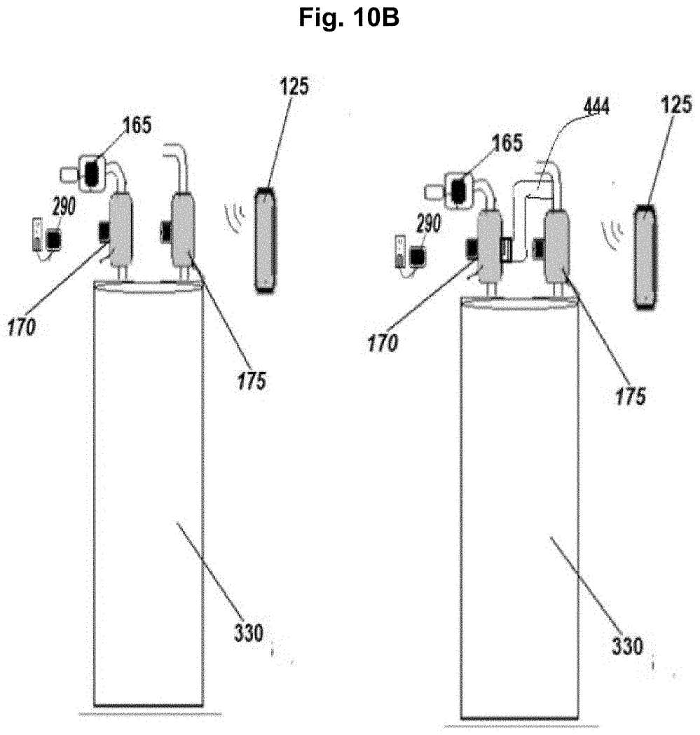

FIG. 10A Illustrates the “A I Variable Speed Valves with SCN” and its connectivity between the solar powered central controller (285) and a plurality of solar powered local controllers (290). Furthermore, the plurality of local controllers (290) is connected to sensory inputs, solenoid valves, and/or Variable Speed Valves outside a user's home. Moreover, the plurality of local controllers (290) is connected to a plurality of systems, at a plurality of local water supply connections, such as: a shower (345), a tub (350), and/or a swimming pool (180). Solar power is the conversion of energy from sunlight into electricity, either directly using photovoltaic s (PV), indirectly using concentrated solar power, or a combination. The solar power panel (190) is either embedded with the user's central controller (285) user interface and/or the solar panel (190) can be an external device. The central controllers (285) are either a self-contained wired and/or wireless controller with user interface inputs such as physical switches, motion sensors, voice command, touch screen, and/or any input type. The central controller (285) can also be a mobile device, and/or a computation Device. The central controller's (285) is utilized to send and/or receive control signals to and/or from a plurality of local controllers (290), in which are connected to the shower (345), the tub (350), and/or the swimming pool (180). The local controllers (290) also have there on user interface to control there on individual peripheral devices. This particular local controller (290) that's connected to the shower's (345) local water supply is constructed with Hot water (170) and/or cold water (175) Variable Speed Valves and water monitoring sensors (165). The central controller (285) and/or the local controller (290) can monitor and/or control the temperature, pressure, and/or flow of water which is outputting from the shower (345). The shower (345) system can, set and/or save, a plurality of functions in which allow the apparatus to output a predetermined temperature, on a predetermined time schedule, and/or the user can play a predetermined song utilizing the apparatus's wired/and or wireless audio system (505). The particular local controller (290) that's connected to The Tub (350) local water supply is constructed with Hot water (170) and/or cold water (175) A I Variable Speed Valves, water level sensors (360), and/or water monitoring sensors (165). The central controllers (285) and/or the local controllers (290) can monitor and/or control the temperature, pressure, and/or flow of water which is flowing into the tub (350), furthermore, the tub (350) system has water overflow protection sensors (360) that will never let a user's tub (350) over flow. Also, a user can set and/or save a plurality of settings to operate the peripheral on a predetermined temperature, a predetermined volume of water, a predetermined water pressure, predetermined time schedule, and/or the user can play a predetermined song utilizing the apparatus's wired/and or wireless audio system (505). The particular local controller (290) that's connected to the swimming pool (180) local water supply is constructed with Variable Speed Valves (100), water level sensors (360), and/or water monitoring sensors (165). The central controllers (285) and/or the local controllers (290) can monitor the temperature and/or control the flow of water which is flowing into the swimming pool (350). Furthermore, the swimming pool (350) peripheral has wired and/or wireless water overflow protection sensors (360). The water overflow protection sensors (360) are constructed to never let a user's swimming pool (350) water level get low and/or will never let the water over flow. These features allow full automation fill and/or re-fill the water in the pool. The swimming pool (350) peripheral can set and/or save a plurality of functions, in which allow the peripheral (350) to output a predetermined volume of water into the pool, a predetermined time schedule to fill up the pool, and/or the user can play a predetermined song utilizing the apparatus's wired/and or wireless audio system (505) while in the pool. The Swimming pool Peripheral device is also constructed to control the pressure and/or flow of water for a drip system, mist system, swamp cooler unit, and/or an air conditioner unit. The sensory inputs (360) will determine the water temperature, water pressure, water level, moisture level, PH, EC, TDS, PPM, for the drip system, mist system, swamp cooler, and/or air conditioner systems.

FIG. 10B Illustrates the “A I Variable Speed Valves with SCN” and its connectivity between the central controller (125), local controller (290), and a water heater (330) system. The central network controller (125) in this particular illustration is a mobile device and/or a computation Device. The central controller (125) is utilized to send and/or receive control signals to and/or from the local controller (290), in which will control the Variable Speed Valves connected to the peripheral's water supply. The local controller (290) is directly connected to the Sensors and Variable Speed Valves at the local water supply lines upon the Water heater (330). Moreover, the local controller (290) has its own user interface to control the Water heater (330) peripheral device as well. The central controller (125) and/or the local controller (290) can monitor and/or control the temperature, pressure, and/or flow of water which is flowing through the Hot water (170) and/or cold water (175) Variable Speed Valves. The Hot water (170) Variable Speed Valve controls the hot water input which is flowing into the user's home and the cold water (175) Variable Speed Valves controls the water flowing into the inlet of the Water heater (330) peripheral device. Furthermore, the Water heater (330) peripheral also has water sensors (165) which are utilized to monitor earthquakes (shaking), temperature, water pressure, and/or water flow-rate. The Water heater (330) peripheral can set and/or save settings for automatic water cut-off in case of emergencies. A user can also set and/or save settings for the peripheral to output a predetermined temperature into a user's home, a predetermined volume of water, and/or to operate only between a predetermined time schedule into a user's home and or business. The greatest feature of the hot water heater peripheral is the temperature controller functions, wherein a user can control the hot water temperature, going into their home, via a central and/or local controller. This will be performed by utilizing a multi-port Variable Speed Valve. The installer will connect the output of the hot water line coming out of the hot water heater into a first inputs of the multi-port Variable Speed Valve. Next, the installer will utilize the reroute line (444) and route a cold-water supply to the second input of the multi-port Variable Speed Valve. Lastly, the installer will connect the output of the multi-port Variable Speed valve to the hot water main line going into the user's home. Now the User will be able to control their hot main water temperature and/or pressure going into their home and/or business, via a central (125) and/or local controller (290), while also, being able to control how fast the Variable Speed valve actuate open and/or close.

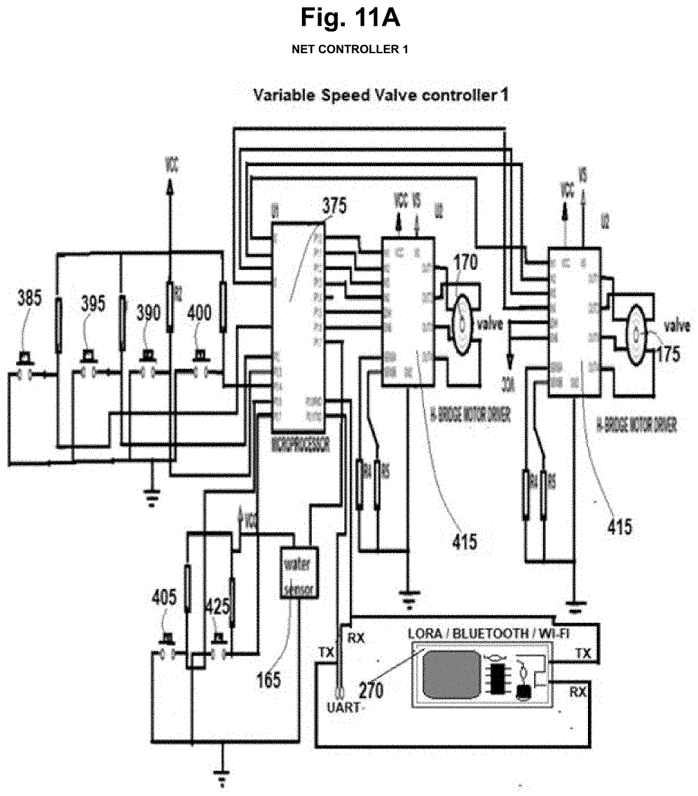

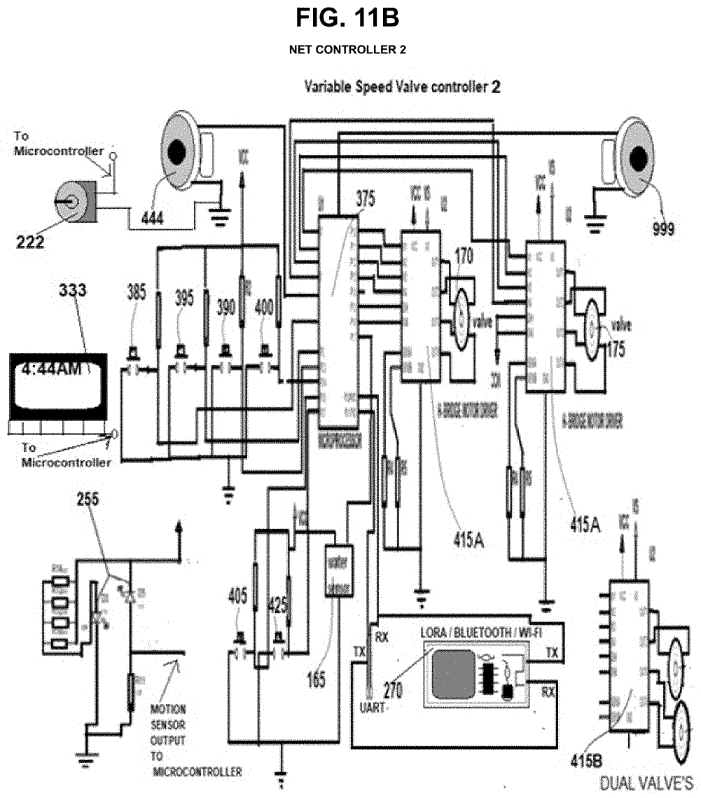

FIG. 11A Illustrates a first schematic to the “A I Variable Speed Valves with SCN” controllers user interface and its connectivity to a plurality of inputs, outputs, sensors, and/or Variable Speed Valves constructed with dc motors, ac motors, and/or stepper motors. This electronic schematic depicts the user interface upon the central controller (285) and/or the local controllers (290) (130). The user interface consists of a plurality of inputs, in-which the inputs are inputted into the microcontroller (375), to send a control signal to one or more drivers circuits (415), furthermore, the driver circuits then send an amplified signal to proportionally actuate the plurality of Variable Speed Valves. ((170) and (175)). The plurality of input switches upon the user interface hot+ (385) hot − (395) cold+ (390) cold− (400) warm + (405) warm − (425), and the menu (365) input. The hot+ (385) input proportionally opens Variable Speed valves associated with the hot water. The hot − (395) input proportionally close Variable Speed valves associated with the hot water. The cold+ (390) input proportionally open Variable Speed valves associated with the cold water. The cold-(400) input proportionally close Variable Speed valves associated with the cold water. The warm + (405) input proportionally open Variable Speed valves associated with the hot and cold water in unison. The warm − (425) input proportionally close Variable Speed valves associated with the hot and cold water in unison. The menu input (365) is used upon the central controller, to select a different “Variable Speed Valves with SCN” peripheral system in which it will fully control, but also is utilized to select, save, and/or change data in various functions in conjunction with the “Variable Speed Valves with SCN” plurality of peripheral systems. The menu input (365) is used upon the local controller (290) (130) to select, save, and/or change data only in various functions in conjunction with the, locally connected, “Variable Speed Valves with SCN” peripheral system. The driver circuit (415) was constructed with a full H-bridge and/or half H-bridge IC. The H-bridge driver circuit (415) is utilized to amplify the signal from the microcontroller (375), to drive the plurality of motorized valves ((170) and (175)), hence, the H-bridge driver circuit (415) is utilized to switch polarity of the Variable Speed valves, which the polarity is switched upon the driver, to make the Variable Speed valves proportional actuate open and/or closed. The Variable Speed Valves ((170) (175)) that are utilized in this particular schematic are stepper motor driven, which also means exact control of the motorized valves ((170) (175)) due to the apparatus being able to change the step size of the stepper motor to proportionally actuate the stepper motor constructed motorized valves ((170) (175)) in steps as low as millimeters. The Variable Speed valves that are utilized in this particular schematic can also be dc motor or servo motor driven Variable Speed Valves. This also means exceptional control of the local water supply due to dc motor Variable Speed Valves being able to proportionally control the pressure and/or flow of the local water supply. This particular setup can control 4 dc motor driven Variable Speed Valves, two dc motor and one stepper motor driven Variable Speed Valves, 10 or more servo driven motorized valves, and/or can control two stepper motor driven Variable Speed valves. A user can connect 100 or more Variables speed Valves to a plurality of local controllers, and furthermore control every single Variable Speed Valve from a single central network controller. The water sensory (165) inputs determine the water temperature, water flow-rate, water pressure, water oxygen level, water hardness, total chlorine in water, mercury in water, metals in water, fluoride in water, alkalinity, TDS (PPM), EC, and/or PH level in water. All of the water sensory inputs (165), utilized in conjunction with the apparatus, are commercially sold and communicate with the microcontroller(s) (75) through an input/output pin. The water sensory inputs (165), that was stated above will, depending on the end user needs, all be utilized in conjunction with one or more “Variable Speed Valves with SCN” peripheral devices, Furthermore, the water sensory (165) inputs send and/or receive data, to and/or from, the microcontroller (375) to monitor, determine, and/or to save sensory data that was recorded due to different types of water activity at a local water supply. The sensory inputs can also automate the actuation of a Variable Speed Valves. The UART communication (270) is the communication method that was utilized, upon the microcontroller, to communicate with the wired and/or wireless Transceiver (270) communication devices. The “Variable Speed Valves with SCN” will use a plurality of wireless communication devices to communicate with each “Variable Speed Valves with SCN” peripheral device, furthermore, the plurality of wireless communication devices that are used in conjunction with the “Variable Speed Valves with SCN” are LoRa-Wan, Zigbee, Bluetooth, WIFI, and/or any type of Radio Controller device. The Radio Controllers stated above are commercially sold modules that contains an on-board antenna, an on-board radio signal controller, and an on-board microcontroller. Using a radio-controlled type of communication system allows operation of the apparatus from anywhere around the user's home and/or business, hence the said radio controller devices also allow an internet connection to operate the “Variable Speed Valves with SCN” from anywhere in the world. The transceiver communication device in conjunction with all “Variable Speed Valves with SCN” peripheral devices will be able to operate in an online and/or offline network. The peripheral systems that this schematic apply to are shown in (FIG. 1-FIG. 11B) shower local supply of water peripheral, tub local supply of water peripheral, swimming pool local supply of water peripherals, water heater local supply of water peripheral, and/or a plurality of pipelines peripheral. This schematic also applies to other peripheral systems of the “Variable Speed Valves with SCN”, wherein, the system electronically controls the valve actuation speed, the flow of a pipeline, and/or the pressure of a local pipeline via a controller, sensors, and/or Variable Speed Valves.

FIG. 11B Illustrates a second schematic of the “A I Variable Speed Valves with SCN” controllers user interface and its connectivity to a plurality of inputs, such as, microphone (444), switches, motion sensor (255), sensory inputs (165), and/or Touch Screens (333). Moreover, the controller is constructed with outputs, such as, Speakers (999), Sensors (165), LED(s) (255), LCD(s) (333), vibration motors (222), and/or outputs in-which connects to one or more solenoid Valves ((415A (170) (175) or (415B)) and/or Variable Speed Valves ((415A (170) (175) and (415B)). The Plurality of Leds, LCD screens, vibrator motors, touch screens, and/or speakers are utilized as outputs to output auditory, visual and/or tactile indications to a user. The system upon this schematic can operate any variable speed type motorized Valve and/or sensors, wherein the actuation device is a Solenoid, DC motor, AC motor, Servo motor, and/or Stepper motor. This electronic schematic also depicts, an example, of a plurality of different user interfaces upon the central controller (285) and/or the local controllers (290) (130), in which the controllers can be used in all figures. The user interfaces consist of a plurality of inputs, in-which the inputs are inputted into the microcontroller (375), to send a control signal to one or more drivers circuits (415), furthermore, the driver circuits then send an amplified signal to proportionally actuate the plurality of Variable Speed Valves. The plurality of inputs upon the user interface are hot+ (385) hot − (395) cold+ (390) cold− (400) warm + (405) warm − (425), VSV select input (580), and a menu (365) input. The Speed settings can be adjusted in the menu settings and/or a user can set an input of their choice to set the speed of the Variable Speed Valve. The hot+ (385) input proportionally opens Variable Speed valves associated with the hot water. The hot − (395) input proportionally close Variable Speed valves associated with the hot water. The cold+ (390) input proportionally open Variable Speed valves associated with the cold water. The cold − (400) input proportionally close Variable Speed valves associated with the cold water. The warm + (405) input proportionally open Variable Speed valves associated with the hot and cold water in unison. The warm-(425) input proportionally close Variable Speed valves associated with the hot and cold water in unison. The menu input (365) is used upon the central controller to select a different “A.I Variable Speed Valves with SCN” peripheral system in-which will be fully controlled, but also is utilized to select, save, and/or change data in various functions in conjunction with the “Variable Speed Valves with SCN” plurality of peripheral systems. The menu input (365) is used upon the local controller (290) to select, save, and/or change data only in various functions in conjunction with the, locally connected, “A.I Variable Speed Valves with SCN” peripheral system. The VSM select input (580) is used upon the central controllers (285) and/or the local controllers (290) for a user to select one or more solenoid Valves and/or Variable Speed Valves) to actuate, open and/or closed, at a user's particular local piping supply. The VSV select input (580) can be used on FIG. 6-FIG. 11B to, start and/or stop, the flow of water at the local water supply connected to the “Variable Speed Valves with SCN” sink peripheral. The VSV select input (580) can be used on the shower and/or tub peripheral to, start and/or stop, the flow of water which flows through the shower local water supply and/or the flow of water which flows through the tub's local water supply. The VSV select input (580) can be used on the toilet peripheral to, start and/or stop, the flow of water which flows through the toilet's local water supply and/or if multiple toilets are present, the VSV select input (580) can select to enable or disable one or more toilets. If the toilet is disabled it cannot flush. The VSV select input (580) can be used on the kitchen peripheral to, start and/or stop, the flow of water, at each local water supply, which flows through the faucets local water supply, the osmosis system/faucet local water supply, and/or the pot-filler's faucet local water supply. The VSV select input (580) can be used on the pipelines peripheral to, start and/or stop, the flow of water in which flows through each individual branch of pipes, and furthermore, the pipeline peripheral can also control the pressure of each individual Pipe. If the pipeline peripheral was connected in a very large building/skyscraper building, the VSV select input (580) can, start and/or stop, the flow of water which flows to each floor of the building and/or is utilized to, start and/or stop, the flow of water which flows to each local water supply of the building, and moreover, the peripheral can also, control the water pressure and/or flow of water at each Variable Speed Valve connected in the building. The driver circuit (415) was constructed with a transistor(s), Mosfet(s), Darlington pair, and/or one or more H-bridge. The driver circuit (415) receives a PWM signal from the microcontroller to proportional actuate the motorized valves open and/or closed. This is a means to actuate a Variable Speed Valve at a plurality of speed settings and/or distribute exact flow and/or pressure control of a local Variable Speed Valve, due to the gearing system and PWM signal operations. This particular setup can control 6 dc motor driven Variable Speed Valves, two dc motor and two stepper motor driven Variable Speed Valves, 10 or more servo driven Variable Speed valves, and/or can control three stepper motor driven Variable Speed valves. The apparatus can control, 10 or more servo driven Variable Speed valves, without a driver, due to the fact that a servo motor only needs a single signal from a microcontroller to be operated. The Vibrator circuit (222), is used as a physical/tactile indicator to the user. It can be set to vibrate the controller, before and/or after, a peripheral function starts and/or complete. A user can connect 100 or more Variables speed Valves to a plurality of local controllers, and furthermore control every single Variable Speed Valve from a single central network controller. The sensory (165) inputs determine the water temperature, water flow-rate, water pressure, water oxygen level, water hardness, total chlorine in water, mercury in water, metals in water, fluoride in water, alkalinity, TDS (PPM), EC, and/or PH level in water. Photo/Light sensors will also be utilized to Power up and/or power down the device. Photo/Light sensors will also be used to automate a user's set night time functions and/or day time functions. For example, a photo sensor will be utilized instead of a timer to automatically actuate one or more Variable Speed valves, in-which will turn on a sprinkler system at night time. Another example, pertaining to the photo sensors, is wherein a user can set the photo sensor to power down the device at night time and set it to power-on at day time. A PIR Sensor will also be utilized for long distance human sensing, animal sensing, and/or object sensing. Sensors pertaining to a digital scale will be utilized in conjunction with the plurality of system controllers. For example, the top/face of a local and/or central controller has sensors to, if the controller is laid on a flat surface and laying down on that surface face up, a user can weigh food, substances, and/or liquids in measurement systems of the following units: lbs., ounces, liters, milliliters, grams, kilograms, and many more. All of the sensory inputs (165), utilized in conjunction with the apparatus, are commercially sold and communicate with the microcontroller(s) (75) through an input/output pin. The sensory inputs (165), that was stated above will, depending on the end user needs, all be utilized in conjunction with one or more “Variable Speed Valves with SCN” peripheral devices, Furthermore, the water sensory (165) inputs send and/or receive data, to and/or from, the microcontroller (375) to monitor, determine, and/or to save sensory data that was recorded due to different types of activity at a local Variable Speed Valve. The sensory inputs can also automate the actuation of a Variable Speed Valves. The UART communication (270) is the communication method that was utilized, upon the microcontroller, to communicate with the wired and/or wireless Transceiver (270) communication devices. The “Variable Speed Valves with SCN” will use a plurality of wireless communication devices to communicate with each “Variable Speed Valves with SCN” peripheral device. Furthermore, the plurality of wireless communication devices that are used in conjunction with the “Variable Speed Valves with SCN” are LoRa-Wan, Zigbee, Bluetooth, WIFI, and/or any type of Radio Controller device. The Radio Controllers stated above are commercially sold modules that contains an on-board antenna, an on-board radio signal controller, and an on-board microcontroller. Using a radio-controlled type of communication system allows operation of the apparatus from anywhere around the user's home and/or business, hence the said radio controller devices also allow an internet connection to operate the “AI Variable Speed Valves with SCN” from anywhere in the world. The transceiver communication device in conjunction with all “AI Variable Speed Valves with SCN” peripheral devices will be able to operate in an online and/or offline network. The LoRa-Wan device have a Long range and can signal hop to get to the device it needs to control. If the user has the Lora-Wan device connected systems, the word LoRA-Wan is an acronym for Long Rage wide area network. On average, in an urban environment with an outdoor gateway, you can expect up to 2- to 3-km-wide coverage, while in the rural areas it can reach beyond 5 to 7 km. This aspect will allow a user to be able to operate a plurality of “Variable Speed Valves with SCN” in a long-range Network without the need for an internet connection. The peripheral systems that this schematic apply to are shown in (FIG. 1-FIG. 11B) shower local supply of water peripheral, tub local supply of water peripheral, swimming pool local supply of water peripherals, water heater local supply of water peripheral, and/or a plurality of pipelines peripheral. This schematic also applies to other peripheral systems of the “A.I Variable Speed Valves with SCN”, wherein, the system electronically controls the valve actuation speed, the flow of a pipeline, and/or the pressure of a local pipeline via a controller, sensors, and/or Variable Speed Valves.

### CONCLUSION

In Conclusion, Various embodiments may include variations in the shape, material, construction method, size of various constructed machined parts, adjustable gearbox, motors, and/or valves used in conjunction with the “AI Variable Speed Valves with SCN”. Various embodiments may also allow for variations in the design of the electronic components used in conjunction with the “AI Variable Speed Valves with SCN” controllers.

The World that we live in today is innovating rapidly. Saving water while saving time by way of the “A.I Variable Speed Valves with SCN”” is mandated. According to various embodiments of this invention, “The “AI Variable Speed Valves with SCN” will control all home/business plumbing needs. The “AI Variable Speed Valves with SCN”, whether use is for water, Oil, Gas, and/or Air piping systems, indoor or outdoor, or whether using the “Variable Speed Valves with SCN” for preferred Pressure regulation, flow control, and/or temperature control, will move precisely and accurately to the position the user require. Furthermore, a user can control the actuation speed of the Variable Speed Valve Electronically and/or manually. This Artificial Intelligent system has to be taught in order for it to Operate at full potential. Every time a user changes a setting upon the system, the apparatus will save data in its memory and will remember exactly how to reach any functions in which was previous set. The apparatus can learn and/or automatically adapt to any sensors and piping system. Furthermore, the system will start learning on its own. Home and Business automation with the “Variable Speed Valves with SCN”, with or without, the Controller will substantially set a user at ease financially (water/gas bills) and keep the user stress free by accessing your Utilities more conveniently. In the Industry of Plumbing, Oil, Gas, and/or Air utilities today the need for easier application is essential. The “A.I Variable Speed Valves with SCN” will allow all users to save preferred valve actuation speed, pressure, and/or temperature by one press of an input. The system can autonomously output a predetermined quantity of water, air, gas and/or oil by a single press of an input. Such said inputs include: voice command, motion sensors, touchscreen, Sensors, and/or push buttons to control the said apparatus. Again, the “AI Variable Speed Valves with SCN” can and will be utilized for electronic distribution of not just water, but also oil, air, steam, gas, and any other distribution system that's controlled or can be controlled by a Motorized Valve. These systems can adapt and learn in any environment. Depending upon which valve is utilized to create the electronic valve, the system will be titled as, for example, an Electronic Rationalizing Valve system, Electronic Rationalizing globe-valve system, and/or Electronic Rationalizing Ball-Valve system. Moreover, the acronym for the system's is ERB. Please take into consideration that this, electronically operated valve, will and/or can be controlled by any apparatus that can control sensors, motors, and/or solenoids. The “A.I Variable Speed Valves with SCN” will be assembled with any type of motor, solenoid, sensory inputs, and/or valve assembly and moreover, will replace all regular valves and motorized valves in the near future.

I claim:

1. The Artificial intelligent motorized valve with an automated adjustable gearbox controlled in a network comprising:
One or more actuating devices, which received multiple signals from a controller to convert digital pulses into variable speed mechanical shaft rotation to proportionally and/or autonomously actuate a Valve, the actuating device connected to an adjustable gearbox to adjust actuating speed of the Valve; the adjustable gearbox being autonomously and/or manually adjustable to a plurality of different gear pattern settings to vary the speed and/or torque of the valve; one or more driveshafts which links the adjustable gearbox to the valve; internal and/or external sensory devices in-which are utilized to monitor, learn, determine, and/or control activity at a motorized valve, and/or sensory devices in-which are utilized to automate the actuation of the motorized valve; an emergency shut-off handle connected to the valve for shutting off the valve manually in case of emergency; wherein the motorized Valve electronically and proportional output a precise fluid temperature, a precise quantity of air, a precise predetermined quantity of liquid, a precise predetermined quantity of gas, a precise predetermined quantity of oil, a specific valve position, a precise fluid pressure, and/or a precise air pressure.

2. The motorized valve of claim 1, wherein the one or more actuating device(s) is a servo motor and/or stepper motor.

3. The motorized valve of claim 1, wherein the one or more actuating device(s) is a DC motor, AC motor and/or solenoid.

4. The motorized valve of claim 1, wherein the motorized valve is constructed with a hose-bib type valve and/or a multi-port Valve.

5. The motorized valve of claim 1, wherein the motorized valve is constructed with a ball valve and/or a globe Valve.

6. The motorized valve of claim 1, wherein the motorized valve is constructed with a butterfly valve, diaphragm valve, and/or any valve type.

7. The motorized valve of claim 1, wherein the emergency shut off handle is constructed as a removable device and/or stationary device.

8. The motorized valve of claim 1, wherein the sensory inputs are utilized to monitor, control, learn, automate, teach, and/or determine a precise liquid temperature, liquid flow-rate, liquid pressure, air pressure, liquid level, substance detection, water oxygen level, water hardness, toxic in water, fluoride in water, alkalinity, TDS (PPM), EC, and/or PH level in water.

9. The motorized valve of claim 1, wherein the motorized valve has a position sensor and/or switch to monitor, calculate, automate, and/or determine valve position.

10. The motorized valve of claim 1, Wherein the motorized valve is a self-powered wireless controlled device and has batteries, a solar panel, and/or water turbine generator to power the system and/or to recharge system batteries.

11. The Artificial Intelligent Network Control System for Electronic Valves comprising:
An Artificial Intelligent Network control system to monitor, automate, determine, learn, instruct, and/or control the flow and/or pressure at one or more Motorized Valves and/or solenoid valves in a network, and moreover, can variably control the speed in conjunction to how fast the valves actuate open and/or closed, the control system further includes;
a plurality of local controllers wherein each local controller includes: a transceiver, a first user interface for inputting control signals to control a flow and/or pressure of water, air, oil, and/or gas, and a first processor wherein the first processor receives user inputs from the first user interface and/or one or more sensor inputs and outputs first signals to control Solenoids and/or motorized valves connected to a local piping supply to control the pressure and/or flow of water, air, oil, and/or gas wherein the user inputs is a command to output a predetermined quantity of liquid, a predetermined liquid pressure, a predetermined liquid temperature, and/or output water, air, oil, and/or gas on a predetermined time schedule; and the sensory inputs causes the first processor to start and/or stop system power or to start and/or stop the flow of water, air, oil, and/or gas; and a central controller for communicating with each of the local controllers, wherein the central controller has a second user interface to send and/or receive control signals for monitoring and/or controlling the pressure and/or flow of water, air, oil, and/or gas at each of the local controllers, a second transceiver for communicating with each of the local controllers, a second processor for receiving the control signals from the second user interface wherein the second processor uses the second transceiver to send the control signals to one or more local controllers to control the pressure and/or flow of water, air, oil, and/or gas at the local controller and wherein the central controller receives input control signals from each of the local controllers.

12. The Artificial Intelligent Network Control System for Electronic Valves in claim 11, further including visual, auditory, and/or tactile outputs at each of the central controllers and/or at each of the local controllers to indicate the status of one or more Valves at a central controller and/or local controller.

13. The Artificial Intelligent Network Control System for Electronic Valves in claim 11, wherein the first and/or the second user interface is constructed with one or more motion sensors, LCD, touchscreen devices, microphones, and/or any type of switches.

14. The Artificial Intelligent Network Control System for Electronic Valves in claim 11, wherein the first and/or the second transceivers communicates via a wire and/or wirelessly.

15. The Artificial Intelligent Network Control System for Electronic Valves in claim 11, wherein the first and/or the second user interface is constructed with one or more motion sensors to recognize a human, animal, and/or object presence from long distances, short distances and/or for gesture control.

16. The Artificial Intelligent Network Control System for Electronic Valves in claim 11, wherein the first and/or the second user interface is constructed with one or more sensors to send control signals to a local controller and/or central controller to power up the device or wake up the device from sleep mode and/or the sensors will send control signals to power down the device or put the device in sleep mode.

17. The Artificial Intelligent Network Control System for Electronic Valves in claim 11, wherein the local controllers are connected to a piping installation in conjunction with a body of liquid and the sensory inputs determines the level of liquid in the body of liquid and if the body of liquid decrease under the sensory inputs, the body of liquid will automatically start to refill the liquid until the body of liquid reaches the sensory inputs.

18. The Artificial Intelligent Network Control System for Electronic Valves in claim 11, wherein local controllers, valves, and/or sensory inputs monitor, determine, automate, and/or control the liquid temperature, liquid flow-rate, and/or liquid pressure outputting from a hot water heater and/or a local motorized valve supplying hot liquid; and moreover, the controller can be set to, if the liquid is too hot for human use, automatically shut off the hot liquid supply until the liquid temperature is under the predetermined temperature.

19. The Artificial Intelligent Network Control System for Electronic Valves in claim 11, wherein a controller is connected to automate, monitor, and/or control one or more sinks and/or faucets.

20. The Artificial Intelligent Network Control System for Electronic Valves in claim 11, wherein the local controllers are connected to automate; monitor, and/or control one or more showers and/or tubs.

21. The Artificial Intelligent Network Control System for Electronic Valves in claim 11, wherein the local controllers are connected to automate; monitor, and/or control one or more toilets.

22. The Artificial Intelligent Network Control System for Electronic Valves 11, wherein a toilet and/or a toilet's controller can automate, monitor, and/or control a sink, faucet, shower, and/or tub.

23. The Artificial Intelligent Network Control System for Electronic Valves in claim 11, wherein a toilet, a toilet's controller, and/or sensory inputs determine if a toilet was flushed; and/or if the toilet is determined to be flushed, the toilets local controller will send a control signal to the sinks local controller to turn on the water to a predetermined temperature, a predetermined pressure, a predetermined quantity, and/or for a predetermine time period and automatically turn the water off after the predetermined time period has expired.

24. The Artificial Intelligent Network Control System for Electronic Valves in claim 11, wherein the local controllers are connected to automate, monitor, and/or control one or more sprinkler systems.

25. The Artificial Intelligent Network Control System for Electronic Valves in claim 11, wherein the local controllers are connected to automate, monitor, and/or control a swamp cooler and/or air conditioner's local water supplies.

26. The Artificial Intelligent Network Control System for Electronic Valves in claim 11, wherein the controllers can monitor, control, determine, and/or automate the pressure and/or flow, for any type of utility local pipeline, utilizing any type of motorized valves, solenoid valves, and/or sensory inputs.

27. The Artificial Intelligent Network Control System for Electronic Motorized Valves in claim 11, wherein the sensory inputs monitor and/or determines liquid contaminants, liquid purity, TDS, PPM, PH, EC, weight, temperature, pressure, and/or flow-rate Outputting from the local water supply.

28. The Artificial Intelligent Network Control System for Electronic Valves in claim 11, wherein a controller receive and/or save data from the sensory inputs, in which the data is utilized to monitor, calculate, determine, and/or automate one or more valves to output a precise predetermined quantity of liquid and/or air, predetermined temperature of liquid and/or air, predetermined pressure of liquid and/or air, to open or close a valve, and/or open or close a valve for a predetermined time period.

29. The Artificial Intelligent Network Control System for Electronic Valves in claim 11, wherein the central controller, and/or the local controllers has batteries, a solar panel, and/or water turbine generator to power the controllers and/or to recharge system batteries.

30. The Artificial Intelligent Network Control System for Electronic Valves in claim 11, wherein a central controller is housed in a water utility facility and/or gas utility facility to send and/or receive control signals to and/or from a plurality of local controllers and/or sensors to determine, monitor, control, and/or automate the pressure and/or flow of water and/or gas at one or more local controllers connected to electronic valves at one or more main pipelines.

31. The Artificial Intelligent Network Control System for Electronic Valves in claim 11, wherein the central controller is implanted on a smart phone and/or the central controller is implanted on a computation device.

32. The Artificial Intelligent Network Control System for Electronic Valves in claim 11, wherein one or more controllers can manually and/or autonomously control, monitor, determine, and/or automate a plurality of local controllers, valves, and/or sensory inputs connected to one or more home's and/or business's gas and/or water entire piping installation.

33. The Artificial Intelligent Network Control System for Electronic Valves in claim 11, wherein one or more central controller can manually and/or autonomously control an entire city, state, province, and/or world's water and/or gas utility supply in-which is connected to a plurality of local controllers.

34. The Artificial Intelligent Network Control System for Electronic Valves in claim 11, wherein the central controller and/or the local controller operates on a Long-range Wide area network and/or wireless mesh network(s).
